(19) United States
(12) Patent Application Publication
(10) Pub. No.: US 2016/0247418 A1
(43) Pub. Date: Aug. 25, 2016

(54) Microsurgical Training System and Related Methods

(71) Applicant: The Regents of the University of Colorado, a body corporate, Denver, CO (US)

(72) Inventors: Zach Folzenlogen, Denver, CO (US); Joshua Seinfeld, Denver, CO (US); Steven Gensmer, Denver, CO (US); Eric Fauble, Portland, OR (US); Vignesh Patel, Haltom City, TX (US)

(21) Appl. No.: 15/051,206

(22) Filed: Feb. 23, 2016

Related U.S. Application Data
(60) Provisional application No. 62/119,498, filed on Feb. 23, 2015.

(51) Int. Cl. G09B 23/30

(52) U.S. Cl. CPC G09B 23/30

(57) ABSTRACT

The invention relates generally to surgical systems and methods. More specifically, the invention relates to a surgical system and related methods for use in training in order to assist with the development and refinement of surgical skills. In particular, the invention relates to providing a microsurgical training system with interchangeable training modules for strengthening specific surgical skills, such as for improving dexterity while working under a microscope using surgical tools, and for learning and practicing surgical skills, such as developing skills for repairing blood vessels by improving suturing time and quality of suturing.

### FIELD OF THE INVENTION

The invention relates generally to surgical systems and methods. More specifically, the invention relates to a surgical system and related methods for use in training in order to assist with the development and refinement of surgical skills. In particular, the invention relates to providing a microsurgical training system with interchangeable training modules for strengthening specific surgical skills, such as for improving dexterity while working under a microscope using surgical tools, and for learning and practicing surgical skills, such as developing skills for repairing blood vessels by improving suturing time and quality of suturing.

### BACKGROUND

Although there are numerous surgical training products, the supply of microsurgical training products is limited. The few existing training products only have the capability to simulate very specific aspects of microsurgery and lack the ability to incorporate multiple technical challenges that occur during a single procedure.

Expensive virtual reality simulators have the capability to walk through an entire microsurgical procedure, but they fail to provide realistic tactile feedback. It is this feedback that is crucial to improve the dexterity necessary for the surgeons to perform these difficult procedures.

Currently, the best available training option is to use live animal specimens. However, this requires hours of set up, does not allow for rapid repeatability or transportability, and raises ethical concerns. Even using euthanized lab animals can still be very expensive and timely to set up.

Thus, there is a need for a microsurgical training device that can accurately simulate multiple types of technical challenges.

### SUMMARY

The invention relates generally to surgical systems and methods. More specifically, the invention relates to a surgical system and related methods for use in training in order to assist with the development and refinement of surgical skills. In particular, the invention relates to providing a microsurgical training system with interchangeable training modules for strengthening specific surgical skills, such as for improving dexterity while working under a microscope using surgical tools, and for learning and practicing surgical skills, such as developing skills for repairing blood vessels by improving suturing time and quality of suturing.

The invention provides a system for microsurgery training, comprising: an optics component including a magnification lens; a rotational adjustment component rotatable about at least two axes; and one or more module cartridges positionable within the rotation adjustment component for a user to practice surgical skills. In one embodiment, the rotational adjustment component is a gimbal unit.

The invention provides a method for microsurgery training for practicing surgical skills by a user, comprising: providing a module cartridge; inserting the module cartridge into a rotational adjustment component; using an optics component to view the module cartridge; rotating the rotational adjustment component about an axis; and performing one or more tasks within the module cartridge.

In one embodiment, the invention provides a rotational docking station gimbal, comprising, a full gimbal ring capable of providing a roll rotation, wherein said full gimbal ring is a module docking station, a half gimbal ring capable of providing a pitch rotation, and a quarter gimbal ring capable of providing a yaw rotation. In one embodiment, said docking station contains a module. In one embodiment, said quarter ring gimbal has a component for attaching to a base. In one embodiment, said full ring docking station has a foam ring insert.

In one embodiment, the invention provides a cylindrical module cassette having two ends, wherein one end is open, wherein said open end is attached to a lid comprising an opening and a plurality of light-emitting diodes. In one embodiment, said lid further comprises a light switch and an attachment for a retractor bar. In one embodiment, said cassette further comprises an aperture. In one embodiment, said cassette is a plastic. In one embodiment, said cassette further comprises a module, wherein said module comprises a plurality of springs for holding imitation blood vessels.

In one embodiment, the invention provides a cylindrical module cartridge having two ends, wherein one end is open end and a side connecting each end, wherein a plurality of magnets are embedded into said side. In one embodiment, said module further comprises materials selected from the group comprising, a plurality of hoop magnets capable of magnetically attaching to said embedded magnets, a replica of a blood vessel, wherein said blood vessel replica has magnets on each end capable of magnetically attaching to said embedded magnets and a bleb simulating an aneurysm, and at least one magnetic rod with a plurality of beads which are capable of being slid onto said magnetic rod. In one embodiment, said cartridge further comprises at least one magnetic rod and a plurality of beads capable of sliding onto said magnetic rod. In one embodiment, said rods are straight. In one embodiment, said rods have at least one bend. In one embodiment, said module further comprises a lid, wherein said lid has an embedded lighting system, including but not limited to a plurality of light emitting diodes, a control switch, connections to a power source, etc. In one embodiment, said cartridge is located inside of a docking station of a rotational docking station gimbal, wherein said gimbal comprises, a full gimbal ring capable of providing a roll rotation, wherein said full gimbal ring is said cartridge docking station, a half gimbal ring capable of providing a pitch rotation, and a quarter gimbal ring capable of providing a yaw rotation.

In one embodiment, the invention provides a base, wherein said base is capable of attaching to a rotational docking station gimbal. In one embodiment, said base further comprises a rotational docking station gimbal and a module. In one embodiment, said gimbal has an interface attachment for a base. In one embodiment, said base is a stationary base. In one embodiment, said base is a spring base. In one embodiment, said spring base provides a capability of planar movement to said gimbal. In one embodiment, said spring base comprises a sliding aluminum plate, wherein said sliding plate has an attachment for said gimbal, a spring plate made of Delrin, a rubber gasket, a modified boom stand base, wherein the modified boom stand base has a circular area through said for base for exposing said attachment for a gimbal. In one embodiment, a rotational docking station gimbal is attached by said interface attachment to said gimbal attachment of said sliding aluminum plate. In one embodiment, said attachment is a screw attachment by screwing the gimbal interface into the sliding base attachment. In one embodiment, said spring base has the capability for allowing said attached rotational docking station gimbal to move downward and a capability for the movement of said gimbal around and inside of said circular area. In one embodiment, said movement of said rotational docking station is provided when said docking station is moved or pushed downward then moved around the circular area. In one embodiment, said downward movement is provided by the user. In one embodiment, said movement is provided by the user. In one embodiment, said movement is planar movement. In one embodiment, said rotational movement is cylindrical movement on three angles and/or rotational around 1-3 axes. In one embodiment, said base is part of an optical system including a magnifying lens.

In one embodiment, the invention provides a system, comprising, i) a module, and ii) a rotational docking station gimbal, comprising, a full gimbal ring capable of providing a roll rotation, wherein said full gimbal ring provides a module docking station, a half gimbal ring capable of providing a pitch rotation, and a quarter gimbal ring capable of providing a yaw rotation. In one embodiment, said module is located within said docking station of said gimbal. In one embodiment, said module further comprises a cylindrical module cassette. In one embodiment, said module comprises at least one synthetic blood vessel and a plurality of springs for holding said blood vessel. In one embodiment, said module is a cylindrical module cartridge. In one embodiment, said system further comprises a base selected from the group comprising a stationary base and a spring base. In one embodiment, said spring base provides a capability of planar movement to said gimbal. In one embodiment, said system further comprises an optical system.

### DEFINITIONS

To facilitate an understanding of the present invention, a number of tennis and phrases are defined below. The use of the article “a” or “an” is intended to include one or more. As used herein, terms defined in the singular are intended to include those terms defined in the plural and vice versa.

As used herein, the term “surgery” (as a verb) or “operation” refers to a treatment or procedure done to the body of a patient, including but not limited to an incision, a manipulation, sniping, cutting, and the like. Surgery is typically performed using surgical instruments. The patient or subject on which the surgery is performed can be a person or an animal. The use of surgery as a noun refers to a location where a medical practitioner treats or advises patients.

As used herein, the term “microsurgery” refers to surgery requiring a microscope, for example, surgery requiring an operating microscope.

As used herein, the term “operate” as a verb refers to performing a surgical operation.

As used herein, the term “OR” or “operating room” refers to a room in which an operation or surgical procedure is performed.

As used herein, the term “surgical” as an adjective refers to surgery; e.g. surgical skills, surgical instruments, surgical operation, surgical doctors, and the like.

As used herein, the term “surgeon” refers to a medical practitioner who operates on or performs surgery on patients in order to treat injuries or diseases.

As used herein, the term “neurosurgeon” refers to a medical specialist who provides non-surgical and surgical treatments for diseases and conditions affecting the nervous system.

As used herein, the term “user” refers to a person.

As used herein, the term “skill” refers to an ability to carry out a task with pre-determined results, for example accomplishing a task within a given amount of time and/or energy indicates having a skill for accomplishing a result. For example, a skill may be an ability that a person possesses, such as a surgical skill. An example of a general surgical skill is suturing together objects, for example microvessels. A surgical skill may also be organ specific or location specific, such as for a surgical skill related to eye (i.e. optical) surgery, and accordingly a skill for suturing may be organ or site specific, such as suturing specifically related to suturing the area around or in an eyeball (i.e. ophthalmology). Furthermore, a surgical skill may be related to a specific procedure, such as a surgical skill for a specific type of disease or injury, such as for repairing a blood vessel as a brain aneurysm or as a heart aneurysm.

As used herein, the term “optics” refers to characteristics of light, such as the behavior and properties of light, including but not limited to visible light, ultraviolet light, and infrared light.

As used herein, the term “optics component” refers to a part that interacts with light, such as an eyepiece, a magnification lens, etc.

As used herein, the term “optics subsystem” in reference to a system refers to a group of parts that interacts with light, such as a microscope, etc.

As used herein, the term “subsystem” refers to a group of parts to accomplish a task, such as an optics subsystem.

As used herein, the term “microscope” refers to a device or instrument for magnifying an object, i.e. creating an image of an object for a user where the image is larger than the object. A microscope may be an “optical microscope” or “light microscope” referring to a device that uses light in combination with an optical system for magnifying an object. An optical microscope may be a simple microscope having one magnifying lens, such as a magnifying glass. An optical microscope may be a compound microscope having at least two types of lenses, including an ocular lens and an objective lens.

As used herein, the term “stereoscope” or “stereomicroscope” or “dissecting microscope” refers to a device or instrument capable of magnifying a three dimensional object in three dimensions. A stereoscope typically uses light reflected from the surface of an object or light emitted from an object, or light transmitted through an object to create an image for a user. In one embodiment, a stereomicroscope may have eyepiece tubes capable of moving in separate directions from each other. In one embodiment, a stereomicroscope may be a compound microscope.

As used herein, the term “eyepiece” or “ocular” refer to a component at the top of the microscope that a user looks through to observe an object. Standard eyepieces contain a lens having a magnifying power of 10× such that an eyepiece is referred to as a 10× eyepiece or an eyepiece having a power of 10×, or 10× magnification, etc. An eyepiece lens is also referred to as an ocular lens. Optional eyepieces of varying powers are available, typically from 5×-30×. A rubber or plastic eyecup for user comfort may cover an eyepiece.

As used herein, the term “eyepiece tube” refers to a cylindrical part that holds an eyepiece in place above the objective lens.

As used herein, the term “interpupillary distance” or “pupillary distance” refers to the size of the space between the pupils of a user's eyes. This distance between pupils may be different from user to user and thus change the view of an image when looking into an optical system Thus an “interpupillary adjustment” refers to altering the distance between the eyepieces by each user of an optics system. As an example, an optics system may have an “interpupillary adjustment” referring to altering the distance between the eyepieces.

As used herein, the term “papillary” refers to a pupil of an eye.

As used herein, the term “lens” refers to an object or device that focuses or otherwise modifies the direction of movement of light, electrons, etc. As examples, a lens may be an ocular lens, such the lens that is located closest to the eye when a user looks through a magnifying device, and an objective lens, such the lens that is located closest to the object (not considering an auxiliary lens).

As used herein, the term “objective lens” refers to an optical lens on a microscope. An objective lens provides a fixed magnification and/or the capability of movement, for example as a “zoom” movement magnification.

As used herein, the term “zoom” refers to a range of magnification achieved by moving an objective lens closer or further away from an object. A control knob, as shown in FIG. 10, provides the capability to change the zoom magnification.

As used herein, the term “auxiliary lens” refers to a supplemental lens in addition to an objective lens. An auxiliary lens may be located on a stereo or dissecting microscope in between the object and the objective lens.

As used herein, the term “diverging lens” refers to a concave lens that when parallel rays of light pass through it the light rays diverge or spread out.

As used herein, the term “Barlow lens” refers to a diverging lens that alters the working distance between the objective lens and the object under view. A Barlow lens may also alter the size of the field of view. In one embodiment, a Barlow lens is an auxiliary lens.

As used herein, the term “field of view” or “field diameter” refers to an area, typically in millimeters or micrometers, that a user will see when looking into the eyepiece lens of a microscope. The diameter of the field of view changes depending on the magnification.

As used herein, the term “focus” as a verb refers to aligning the parts of an optical system for optimally viewing an object. As one example, a user brings an object into focus by adjusting first a course focus knob to move the objective lens away from the object. Then a user adjusts a fine focus knob on an eyepiece that provides small movements in the eyepiece tubes for providing a sharper image of the object, as shown in FIG. 10. In other words, when an image is “in focus” then the image appears to have sharp edges when viewed by a particular user.

As used herein, the term “aperture” refers to an opening, hole, or gap, such as a space through which light passes in an optical instrument. An aperture may have a fixed opening or it may be adjustable, i.e. has a capability for changing the size of the opening.

As used herein, the term “resolution” refers to a measurement of a distance that is the shortest distance between two points on an object that can be distinguished as separate entities by a user or a camera system.

As used herein, the term “magnification” refers to increasing the size of an image of an object under view, such as a part of an optics system of the present inventions. The magnification of an object can be calculated as a total increase in the size of the image of an object by multiplying the eyepiece magnification (via a lens in the eyepiece, such as an ocular lens), the objective lens magnification, and an auxiliary lens. As an example 10× eyepiece times the magnification from a 5× objective lens and a 0.3× auxiliary lens, there is a total magnification of 15× where × represents “times”.

As used herein, the term “working distance” refers to a distance between the objective lens and an object.

As used herein, the term “platform” or “base” refers to a part on which objects are placed that are intended for microscopic viewing by a user. A base may be a boom stand, a platform, and the like.

As used herein, the term “positionable” refers to a capability of being moved to a particular location.

As used herein, the term “axis” or “axis of ordinate” refers to a straight line of reference, such as an X-axis and a Y-axis. An X-axis reference line and Y-axis reference line may be perpendicular to each other in one dimensional space, i.e. located in the same plane, as in planar X and Y.

As used herein, the term “planar movement” refers to movement within a plane. For example, when X and Y reference lines are in the same plane, then “XY” or “X-Y” planar movement refers to the capability to move in either X or Y directions or a combination of X and Y directions such as for sideways movements and movements in a circle. For example, from a user's perspective, planar movement in the X direction may refer to moving in a left-right or side to side direction, while planar movement in the Y direction may refer to moving in a front to back or back to front. XY planar movement refers to a combined capability to move in both X or Y directions in addition to moving sideways in relation to the X and Y imaginary lines, i.e. as when moving in a circle.

As used herein, the term “rotatable” refers to a capability for a rotational movement around an axis.

As used herein, the term “rotational adjustment” refers to moving an object at an angle of up to three axes, i.e. “Φθψ” angles, such as when rotating a gimbal unit.

As used herein, the term “rotational adjustment component” refers to a part or component capable of providing movement to an object on up to three axes, as one example, a gimbal ring.

As used herein, the term “gimbal” refers to a ring or component that can rotate or pivot on one axis.

As used herein, the term “gimbal unit” refers to a device containing at least one ring and up to three rings, wherein each ring can rotate or pivot on one axis. Thus in one embodiment, a gimbal (unit) can rotate on one axis up to three axes as movements in three-dimensional space. A ring may be a full circle, or a portion of a circle, such as a half ring or a quarter of a ring. Accordingly, an object embedded within or attached to a gimbal unit has a matching capability to rotate as the gimbal rotates.

As used herein, the term “gimbal system” refers to a reference coordinate system, as one example, a cylindrical coordinate representing rotational movement of a gimbal as a three-dimensional coordinate system.

As used herein, the term “rotation” or “rotational” refers to a capability for movement around an angle on a line of reference, in other words, movement about at least one axis such that a rotational movement is at an angle to the axis. For example, rotation may be partial at an angle of at least 1 degree, 25 degrees, 50 degrees and up to but less than 360 degrees or full up to 360 degrees. Rotational movements may also be described as cylindrical movements at an angle, for example, in one, two or three dimensions. As an example, movements at an angle may be referred to by Greek symbols “Φθψ” and by corresponding reference terms, such as roll, pitch and yaw. In one embodiment, a rotational movement at an angle to an axis refers to a cylindrical rotation movement.

A cylindrical rotation movement at a “Φ” or “phi” angle refers to a rotation motion at an axis, i.e. a “roll” axis, for example, when a flying airplane does a partial or complete barrel roll, it is rotating or moving on a roll axis at a “Φ” angle. In one embodiment, a ring or plane of a gimbal unit can move or rotate on a “roll” axis at a Φ angle. In one embodiment, a full ring of a gimbal unit can provide the capability to completely rotate around a roll axis from 0 up to a 360-degree angle from where the movement begins.

A cylindrical rotation movement at a “θ” or “theta” angle refers to a rotation motion on an axis, i.e. a “pitch” axis, for example, when a flying airplane is flying upward or downward, it is rotating or moving on a pitch axis that is perpendicular to a roll axis on a “θ” angle. Thus in one embodiment, a ring or plane of a gimbal unit can provide the capability to rotate or move on a pitch axis. In one embodiment, a half ring of a gimbal unit can provide the capability to rotate or move on a pitch axis from 0 up to 180 degrees.

A cylindrical rotation movement at a “ψ” or “psi” angle refers to a rotation motion on an axis, i.e. a “yaw” axis, for example, when a flying airplane turns from one side to the other, it is rotating or moving on a “yaw” axis, that is perpendicular to a roll axis and a pitch axis. Thus in one embodiment, a ring or plane of a gimbal unit can provide the capability to rotate or move on a yaw axis. In one embodiment, a quarter ring of a gimbal unit can provide the capability to rotate or move from 0 up to 90 degrees.

As used herein, the term “ring” refers to a circular type object. A ring may be a full ring, such that it is an entire circle, a half ring, such that it is a half circle, a quarter ring, such that it is a quarter circle or a part that corresponds to a quarter circle.

As used herein, the term “module” refers to a group of materials that provide a task or challenge, such as springs for holding blood vessels and attached blood vessels for a task of suturing blood vessels, a plurality of embedded magnets and a plurality of magnetic items, such as a blood vessel containing an aneurism for repairing an aneurism, or a plurality of magnetic rods for providing dexterity skills by placing beads or rings onto the rods, or as more examples, a group of parts for constructing an object for acquiring or maintaining or improving dexterity under a microscope, i.e. micromanipulation. In some embodiments, the module is contained within a cylindrical “cassette” wherein the cassette provides the capability for directly fitting the module into the docking station of a rotational gimbal unit. In a further embodiment, the cylindrical cassette has outer wall threads for attaching to matching threads of a lid. In some embodiments, the module fits inside of a module cassette.

When the outer sidewall of the cassette is a part of the module, then the module is a module cartridge. For example, a module cartridge for practicing surgical skills is a cylindrical cartridge which has magnets embedded on the inside of the outer wall of the module cartridge along with the capability for fitting into the docking station of a rotational gimbal unit. In some embodiments, one end of the cartridge has threads for attaching to matching threads of a lid.

As used herein, the term “cartridge” generally refers to a component designed for insertion into another object.

As used herein, the term “docking station” refers to a component capable of receiving a module, including modules contained within a cassette, as part of a cartridge, and the like. As one example, a gimbal unit of the present inventions contains a docking station for receiving, i.e. holding, for examples, a module, including a module cassette, a module cartridge and the like.

As used herein, the term “system” refers to a group of related components for providing a function, as non-limiting examples of systems, an optics (optical) system, a rotational adjustment system, a training module system, etc. When a system is combined with another system then the individual systems are referred to as a “subsystem.” For example, a microsurgical training system if formed by combining at least one or more systems which then may be referred to as subsystems, such as an optics system may be referred to as an optics subsystem when combined with another subsystem forming a training system.

### BRIEF DESCRIPTION OF THE DRAWINGS

FIG. 1: A. Exemplary stereomicroscope (second in from left) with eyepieces (far left), Barlow lens (center), focusing rack (second in from right), and articulating arm (far right). B. Stereo microscope trinocular head with 10× eyepieces (top left), 0.3× Barlow lens (lower left), focusing rack (lower right), and boom stand (far right).

FIG. 2: Exemplary modification (right) of the clevis joint (left), which allowed the microscope to tilt thus causing an increase in the working distance (light colored line on left schematic before moving the clevis joint compared to the longer light colored line on the right schematic after adjustment). Thus modifying the articulating to tilt stereomicroscope increases working distance.

FIG. 3: Exemplary adjustment systems: A. CAD rendering of rotational adjustment through gimbal system. B. Gimbal rotational adjustment system. C. Interchangeable gimbal base for use with detached gimbal (left).

FIG. 4: Exemplary types of training modules providing materials to increase skills and dexterity. Left, a dexterity module for constructing an object using small blocks, i.e. Nanoblock® parts. Right, an anastomosis module materials for providing training in a surgical skill i.e. for microvascular surgery simulation of sewing blood vessels together. Materials include metal springs holding synthetic blood vessels. Users of these modules would additionally need surgical tools, such as forceps, needle and thread, for these tasks. The module on the left is attached to a lid.

FIG. 5: Exemplary module design with dimensions and features.

FIG. 6: Exemplary lid showing an integrated LED (light-emitting diode) lighting system: A. Lighting design integrates ring of LEDs into lid. Integrated LED lighting system showing a switch on the upper surface. B. Underside of the module lid with integrated lighting (switch is shown loser left); and C. powered with battery (left) or plug (right).

FIG. 7: Exemplary pivot and linear action of planar base (Left). Toggle clamp set up for locking (Right).

FIG. 8: Exemplary planar adjustment system: sliding plate X-Y system.

FIG. 9: Exemplary planar adjustment system: A. modified base of AmScope boom stand. B. Spring assisted sliding plate mechanism underneath the gimbal.

FIG. 10: Exemplary microscope & Stand setup with labeled parts.

FIG. 11: Exemplary neurosurgical trainer: gimbal unit with an inserted module (left).

FIG. 12: Exemplary modules: A. Module cartridge showing magnets embedded in outer wall. B. Suture and hoop cartridge showing magnetic hoops and suture thread. C. Aneurysm cartridge showing blood vessels, with blebbing aneurisms, having magnetic ends for attaching to the wall magnets and D. Bead and rod cartridge for dexterity for placing beads (or rings) on straight and bent magnetic rods.

FIG. 13: Exemplary Gimbal Assembly: Part Name: Gimbal Ass_Jan15; Part No. ASSEM1000. Scale 1:2: A. Illustrations of a rotational gimbal (20) showing base (40). Sheet 1 of 2. B. A labeled schematic drawing on a gimbal (20) on base (40). Sheet 2 of 2. See Table 3 for corresponding names of numbered parts.

FIG. 14: Exemplary Gimbal Assembly: Part Name: Gimbal Ass_May5; Part No. ASSEM1000. Scale 1:2. A. Illustrations of a rotational gimbal (30) showing an attached interface (6) for a base. Sheet 1 of 2. B. A labeled schematic drawing on a gimbal (30) including an attached interface for a base (6). Sheet 2 of 2. See Table 5 for corresponding names of numbered parts.

FIG. 15: Exemplary Gimbal Assembly: Part (1) name: Full Ring. Description: Inner ring that supports surgical modules, i.e. a docking station. Part No. P1001. Material: Aluminum 6061-½ sheet. Scale 1:1. A. Top view of flat ring and scale. B. Top view of an upright ring. C. Side view of upright ring showing bolt holes.

FIG. 16: Exemplary Gimbal Assembly: Part (3) name: Half ring. Description: Half ring provides 2nd degree of movement. Part No. P1002. Material: Aluminum 6061-½ sheet. Scale 1:1. Half Ring: 10-24 tapped hole Centered±0.005. A. Top view of flat half ring. B. Side view of vertical ring showing adjustment bolt holes. C. Rear view of vertical ring showing attachment thread hole for quarter ring part.

FIG. 17: Exemplary Gimbal Assembly: Part (2) name: Quarter ring. Description: Quarter ring part connects gimbal to base and provides 3rd degree of motion. Part No. P1003. Material: Aluminum 6061-1; 18-inch sheet. Scale 1:1. A. Side view and scale. B. Scale. C. Scale.

FIG. 18: Exemplary Assembly M1000: Part name (6): interface_Part: Description: Interfaces gimbal between stationary and XY bases. Part No. P1010. Material: Aluminum 6061-1; 1.5″ Rod. Scale 2:1. A. Top view. B. Upside down Side view (6). C. Bottom view.

FIG. 19: Exemplary Gimbal Assembly: Part name: spacer_1. Description: Inner spacer: Part No. P1005. Material: Delrin-ID ¼″ OD ⅜″ tube. Scale 5:1. A. Diagram. B. Size.

FIG. 20: Exemplary Gimbal Assembly: Part name: spacer_2. Description: Outer spacer to provide friction lock. Part No. P1006. Material: Delrin-ID ¼″ OD ⅜″ tube. Scale 5:1. A. Diagram. B. Size.

FIG. 21: Exemplary Gimbal Assembly: Part name: spacer_3. Description: Outer spacer to provide friction lock. Part No. P1007. Material: Delrin-ID ¼″ OD ⅜″ tube. Scale 5:1. A. Diagram. B. Size.

FIG. 22: Exemplary diagram of an XY System Assembly: Part name: XY System_ASSEM. Scale 1:2. A. Top view showing wood wrist rests (light colored double ovals). B. Side view. C. Top front view. D. Side view of front.

FIG. 23: Part name: XY System_ASSEM. Scale 1:2. Part numbers in Table 7.

FIG. 24: Exemplary XY System Assembly: Part name: BaseBoom. Description: main base for microscope and XY movement. Part No. P2001. Cast Iron-modifying existing base. Scale 1:2.

FIG. 25: Exemplary XY System Assembly: Part name: Sliding Plate. Description: sliding part that enables XY translation. Part No. P2003. Material: aluminum 6061-⅜ inch thick 6×6 plate. Scale 1:1.

FIG. 26: Exemplary XY System Assembly: Part name: Rubber_friction. Description: rubber gasket provides friction to lock. Part No. P2004. Material: 6-inch×6-inch-thick neoprene rubber. Scale 1:1.

FIG. 27: Exemplary XY System Assembly: Part name: standoffs_wristrest. Description: mounts to wrist rest and lifts it off of boom base. Part No. P2005. Material: Half inch polished steel shaft. Scale 2:1. A. Diagram. B. Size.

FIG. 28: Exemplary XY System Assembly: Part name: wrist rest. Description: wooden base for upholstering. Part No. P2006. Material: wood. Scale 1:1.

FIG. 29: Exemplary embodiments for packing an exemplary surgical training system, such as a MicroDex, A. Above, Pelican™ case 1400 (small) and below, Pelican™ case 1610 (large) and B. A large Pelican™ 1610 case shown storing the microscope, base, gimbal system, a screw-on lid with integrated lighting, and three training modules with a smaller case to the left.

### DESCRIPTION OF THE INVENTION

The invention relates generally to surgical systems and methods. More specifically, the invention relates to a surgical system and related methods for use in training in order to assist with the development and refinement of surgical skills. In particular, the invention relates to providing a microsurgical training system with interchangeable training modules for strengthening specific surgical skills, such as for improving dexterity while working under a microscope using surgical tools, and for learning and practicing surgical skills, such as developing skills for repairing blood vessels by improving suturing time and quality of suturing.

The lifesaving capabilities of Neurosurgery are dependent on the development of innovative tools that help surgeons push new boundaries in the operation room. Thus, there is a need for a microsurgical training device that can accurately simulate multiple technical challenges, allows for highly repeatable trainings, is transportable, requires very little setup time, and may help improve the dexterity for both new and practicing surgeons.

The present invention contemplates a system comprising a platform that features various surgical modules to help develop surgical skills among new trainees, as well as provide skill refinement for practicing surgeons.

In one embodiment, the present invention contemplates a system, including but not limited to, a docking station gimbal unit and a docking station gimbal unit base. In one embodiment, the system further includes a training module, including but not limited to a surgical simulation module and a nonsurgical simulation module, including but not limited to modules for improving surgical skills, such as dexterity skills. In one embodiment, the module comprises a module cassette. In one embodiment, the module is a module cartridge. In one embodiment, the present invention contemplates a training system further comprising an optics system, i.e. a stereomicroscope.

In some embodiments, the system includes at least one or more additional features that increase the system's level of complexity, see, Table 1, for non-limiting examples of features contemplated for incorporation into a microsurgical training device and system.

TABLE 1
Contemplative features of a microsurgery device and an exemplary
microsurgical training system at various levels of complexity.

| Level I | Level II | Level III |
|---|---|---|
| Optical zoom - 10x | Φθ & XY adjustment - | 2nd view piece |
| | 80 mm | for camera mount |
| Φθ adjustment - all | Adjustable tool aperture - | Protective case |
| corners visible | min 15 mm | |
| Variable tool aper- | Adjustable zoom - range | Wrist rests |
| tures -min: 15 mm w/15 | 2-15x | |
| mm increments | | |
| Working distance >200 mm | Aesthetic design | Bar to mount |
| | | retractors |
| Easy access to practice | Comfortable/intuitive to | Retractor bars |
| modules | use | |
| Self-contained lighting | Designed for mass | 3+ modules for |
| | replication | specific proce- |
| | | dures |
| Transportable by | 2-3 useable modules for | — |
| individual | demonstration | |
| Use with standard table | Robust & easily portable | — |
| Adjustable microscope | Holds basic tools | — |
| height | | |
| 1 mock-up module for | Timer | — |
| demonstration | | |

### I. Microsurgical Trainer Design and Microsurgical Training System.

During the design and development of a microsurgical (i.e. a neurosurgical) trainer and a microsurgical training system, embodiments of systems were produced and tested as parts and systems. In one embodiment, a trainer system comprises a portable platform (i.e. base) capable of attaching to a rotational docking station gimbal (i.e. rotational module docking station gimbal), a rotational module docking station gimbal, and at least one interchangeable module. Each module comprises materials for at least one or more task or challenge whose use is contemplated to assist a user, including but not limited to residents, surgeons, medical personnel, researchers, etc., with improving his/her microsurgical skills and dexterity for performing microsurgical tasks. More specifically, each module is attached to a lid with self-contained LED (light-emitting diode) lighting powered by batteries or wall power via an AC/DC (alternating current/direct current) adapter for providing lighting for optimal viewing of the modules. The lid further comprises a viewing opening for looking into the module (i.e. hole). In one embodiment, a lid additionally comprises at least one interchangeable aperture, where apertures are provided in different sizes in order to change the difficulty of the task or challenge. In some embodiments, using progressively smaller apertures increases the degree of difficulty and provides the realism of working in a narrower operating space.

Additionally, in one embodiment, the present invention contemplates a system (e.g., a Microsurgical Trainer) comprising three subsystems: an optics (optical) subsystem, a rotational adjustment subsystem, and a module subsystem comprising a plurality of training modules. The optical subsystem, in particular as part of a stereomicroscope system, allows the users to adjust the focus, zoom, field of view, and working distance to specifications similar to the settings of an operating room's surgical microscope. The rotational adjustment system is used to position and angle a module contained within a docking station of a rotational gimbal.

In addition to moving the rotational adjustment of the gimbal, a gimbal may be placed or attached to a sliding base or spring base, i.e. platform, to allow the users to further change their perspective and set a specific view. Thus in another embodiment, the components of a training system include but are not limited to: an adjustable optics subsystem for magnification, modular dexterity tasks for the user to practice upon, an adjustable platform with a rotational module docking gimbal in order to reposition and rotate the module contained within the docking area, and lids for module cassettes, module cartridges and the like, where the lids contain self-contained lighting in order to illuminate the viewing area, i.e. work area. In one embodiment, at least one additional feature was incorporated in a system. In some embodiments, at least two or more features are incorporated in a system. See, Table 1 for examples of features.

Some embodiments of a training system refer collectively to a MicroDex Microsurgical Training System. Additionally, MicroDex Microsurgical Training System components may refer to a plurality of items or products configured to help surgeons to improve their dexterity and surgical skills when working with or translated to working with an operating microscope.

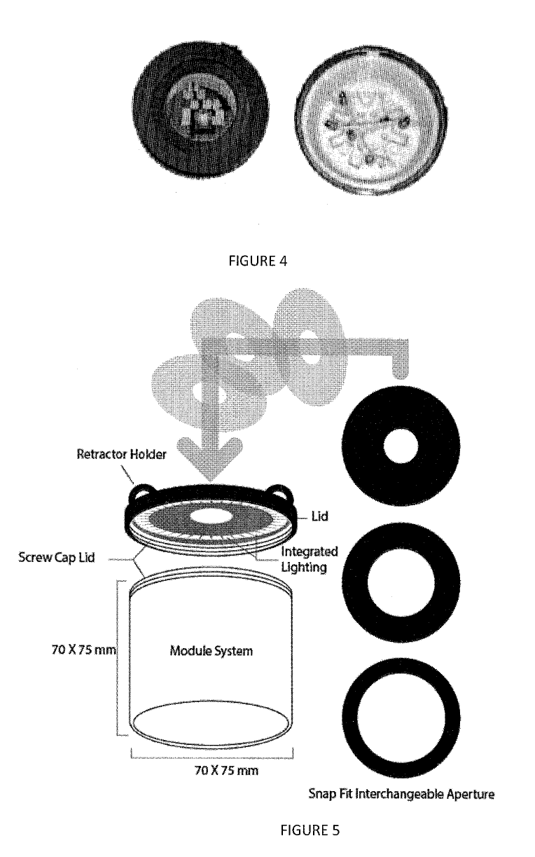

An exemplary surgical trainer, i.e. training system, such as a MicroDex Training System, features interchangeable modules providing a variety of different tasks and games for the users to practice on for improving their surgical skills. FIG. 4 shows exemplary training modules. The modules were housed in a cylinder, i.e. cassette, whose dimensions in millimeters are shown in FIG. 5, with a threaded lid that accommodated different diameter apertures, see, FIG. 4, left and FIG. 5 for examples.

Modules may be contained in cylindrical cassettes or cartridges. Cassettes and cartridges may be translucent (allowing light, but not detailed images, to pass through; semitransparent) or opaque (not allowing light to pass through). Cassettes and cartridges may be produced from plastic, such as a synthetic material made from organic polymers including but not limited to polyethylene, PVC, nylon, etc. Cylinders can be molded into shape while the plastic is soft and then set into a rigid or slightly elastic form. In some embodiments, cartridges made of plastic have a plurality of magnets embedded into the side during fabrication. In some embodiments, magnets are attached to the side of preformed cartridges. Objects or materials intended to attach to the embedded magnets are made of corresponding magnetic material, either a magnet of the opposite pole (i.e. north and south) and/or a material that can be magnetized. Magnetized materials are strongly attracted to a magnet, i.e. ferromagnetic (or ferrimagnetic), including but not limited to iron, nickel, cobalt, and the like.

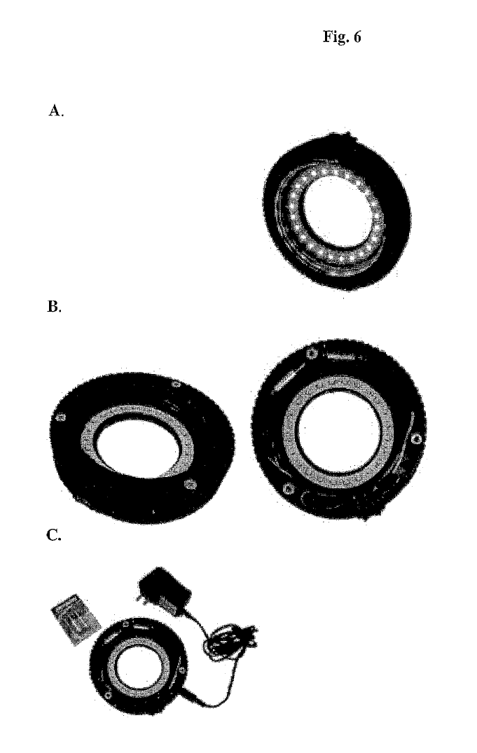

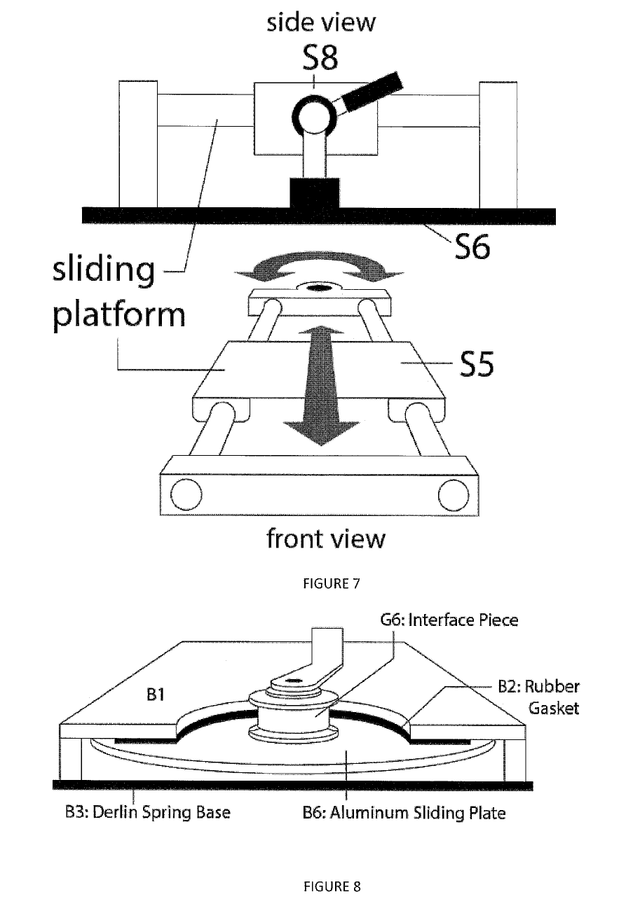

Self-contained lighting was provided as part of a lid, as shown in FIG. 4 left and FIG. 6. In one embodiment, the present invention contemplates additional modules that provide training for a surgeon to simulate surgery and to practice microsurgical skills, in combination with a rotational docking station gimbal, serving as a docking station for a module, as an inexpensive and portable device for operating room simulation training.

Contemplated modules include: developing additional realistic modules for use in practicing specific surgical procedures, incorporating a larger range of surgical tools (e.g. tissue retractors, micro-laparoscopy needles, etc.), and for additional embodiments of the platform. In one embodiment, the platform is designed for more economical commercial manufacturing. In one embodiment, the platform is designed for faster assembly. The following sections describe components of an exemplary Training System.

A. Optics (Sub)System.

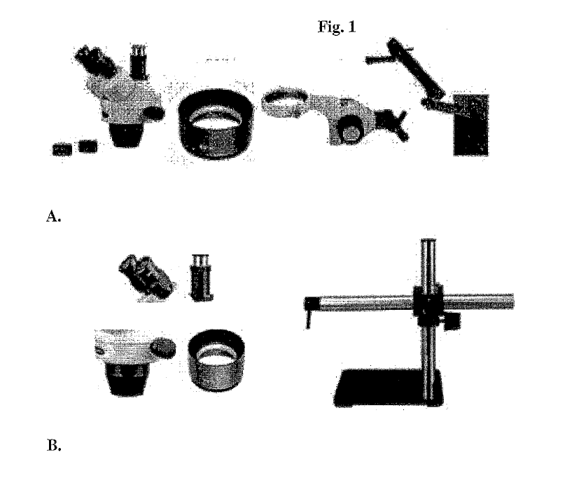

After researching microscopes and investigating alternative optics systems, such as digital microscopes, and glasses with magnification lenses, it was decided that an optical microscope would provide the most realistic experience for the surgeons. A commercially available microscope (AmScope) provided the most effective solution for the optics system. FIG. 1A shows the four main components of this microscope: the stereomicroscope head, the Barlow lens, the focusing rack, and the articulating arm, for one embodiment. In another embodiment, the present invention contemplates a microsurgical training system comprising a stereomicroscope for providing an exemplary optics system contemplated for use in an associated training system product. FIG. 1B shows an optics system comprising four components, as in one embodiment of an optical setup for a system: a stereomicroscope with a trinocular head comprising eyepieces, ocular lens, eyepiece tubes, eyepiece adjustments, and a beam splitter for changing views from the user to a camera, a Barlow lens, a focusing rack comprising an objective lens, and a stand, such as a boom stand. In one embodiment, a microscope system is a stereomicroscope with a boom stand (i.e. an exemplary boom stand was purchased from AmScope). In one embodiment, a microscope system is a stereomicroscope with a Heavy Duty Boom Stand with cast iron base. In one embodiment, a stereomicroscope system is combined with a stationary base. In one embodiment, a microscope system is a stereomicroscope combined with a maneuverable base.

1. Stereomicroscope.

A stereomicroscope with variable magnification between 7×-45× provides sufficient depth perception required to perform surgical tasks. In another embodiment, a stereomicroscope with variable (i.e. including zoom) magnification between 3.5×-45× provided the desired depth of perception required in order to perform certain surgical tasks. Thus in one embodiment, the stereomicroscope is a 3.5-45× Trinocular Zoom Stereo Microscope Head and focusing rack. A trinocular feature with this microscope allows the user to attach a camera in order to document their work.

2. Barlow Lens.

A 0.3× Barlow lens (diverging lens) increases the working distance of the microscope from 4″ to 12″. This also reduces the magnification to a nominal range between 2.1× and 13.5×. Thus in another embodiment of the optics system, a 0.3× Barlow lens (diverging lens) was added. The use of the 0.3× Barlow lens caused an increase in the working distance of the microscope from 4″ to 12″ allowing a greater area of working space for viewing and using the training module. Additionally, this Barlow lens increased the field of view to 2.35″; a field of view desired which encompasses the maximum visible diameter of the practice modules. On the flip side, this Barlow lens caused a reduction in the magnification to a range between 2.1× and 13.5×.

Therefore, in one embodiment, a trade-off of reduced magnification provides a wider field of view and a larger working area for viewing and using a training module. The increase in working area is contemplated for use when working with modules containing tall module items, or taller cylinder modular cartridges.

3. Focusing Rack.

A focusing rack with 3¼″ travel may allow the user the ability to maintain focus for the entire depth of the 75 mm (3″) high modules. In addition, fine focus can be adjusted using the microscope's eyepieces. Thus in one embodiment, the optics system further comprises a focusing rack with 3¼ inch of travel allowed the user the ability to maintain focus for the entire depth of the 75 mm (3″) high practice modules. In addition, fine focus was achieved by focusing the microscope eyepieces.

4. Stand.

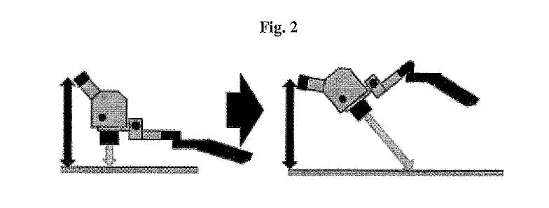

To ensure that the Microsurgical Trainer is comfortable to use, the microscope needs to be adjustable to the user's eyes and position. The microscope may be attached to a stand or base including but not limited to a boom stand, an articulating arm, i.e. articulating arm stand, etc. The microscope is attached to an articulating aim that clamps to the table, in some embodiments. This stand may be modified to allow the microscope to tilt as shown in FIG. 2 (right), increasing the distance from the module to the microscope, and providing a more comfortable viewing angle. In one embodiment, the stereomicroscope was mounted to a focusing rack, which in turn was attached to the articulating arm stand with a clevis fastener held by a clevis pin. By tilting the microscope through the clevis pin, the working distance from the module to the microscope (left) was increased to 12″ (right) while maintaining a comfortable viewing height, as illustrated in FIG. 2. In addition, this viewing angle was representative of the operating microscopes used in an operating room.

For reference, a clevis pin is a bolt type part, threaded or unthreaded, that closes off the straight end of a clevis, i.e. a U-Shaped fastener. As one example, a cotter pin may hold the clevis pin onto the U-shaped fastener. The clevis pin is similar to a bolt, but is only partially threaded or unthreaded with a cross-hole for a split pin.

B. Maneuverable Platform.

During a surgery, surgeons have the ability to orient his/herself and the microscope to improve their ability to perform the surgery successfully. In other words, during an operation, surgeons have the ability to maneuver themselves and the operating microscope into a position that maximizes their dexterity and yields the best approach to successfully perform surgery. To simulate this change of perspective, the modules need to be able to rotate about all three axes.

1. Module Rotational Adjustment Subsystem: Gimbal Unit.

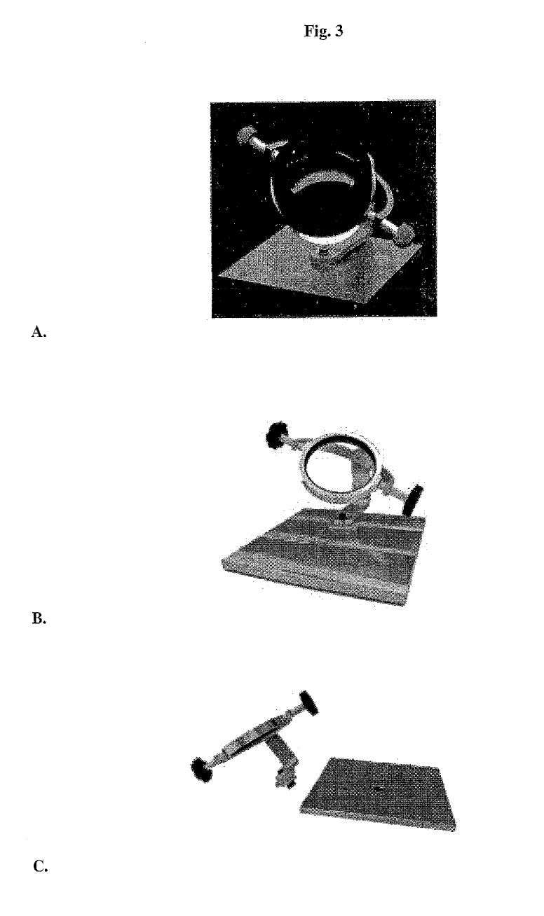

The holder of a module was designed as a rotational adjustment (sub)system with a capability to rotate around three axes. A gimbal system was chosen over a ball joint as the preferred solution for a rotational adjustment of the training module (20 and 30). FIG. 3 is directed to an illustration of the rotational adjustment component of the microsurgical training system according to one embodiment of the invention. After a few initial designs, a gimbal system consisting of a full, half, and quarter ring was constructed, as shown in FIG. 3A gimbal (20) and base (40). Another gimbal embodiment (30) is shown in FIG. 3B attached to base (40). FIG. 3C shows a gimbal unit (30) with a corresponding stationary base (40) right. A gimbal system was intuitive to use, and more compact, with the center of rotation lying within the modules, than for other contemplated rotational systems.

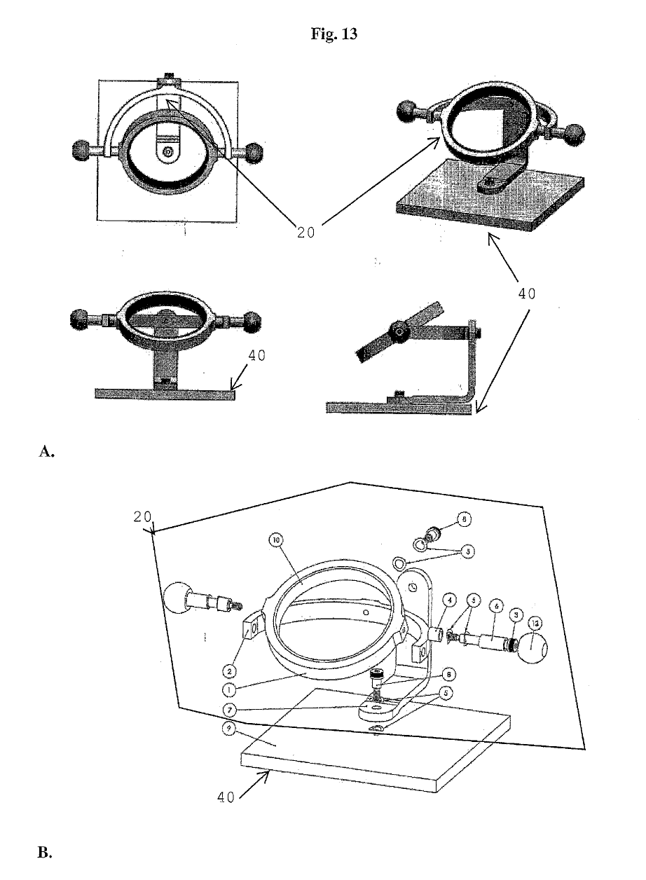

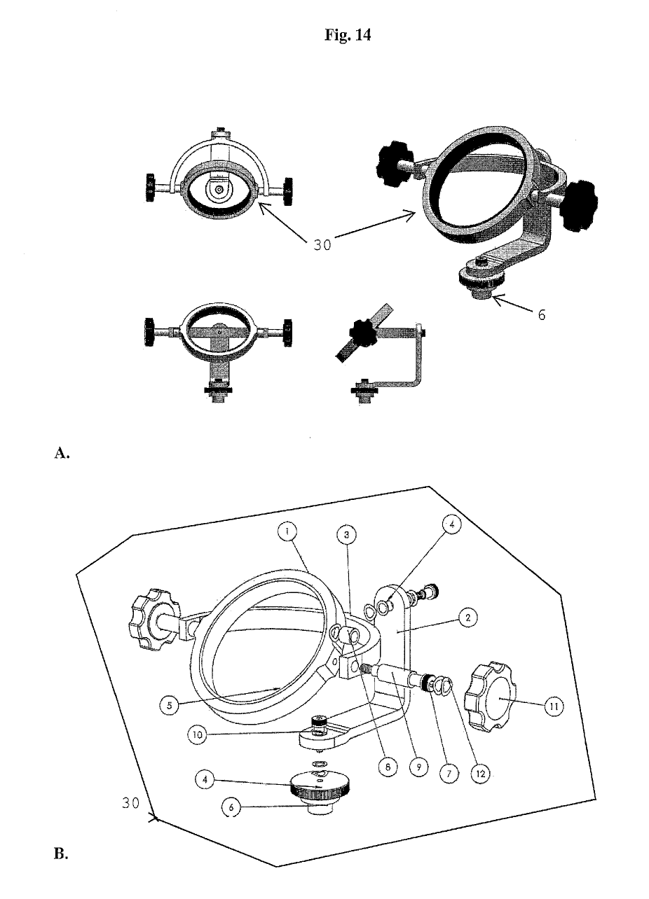

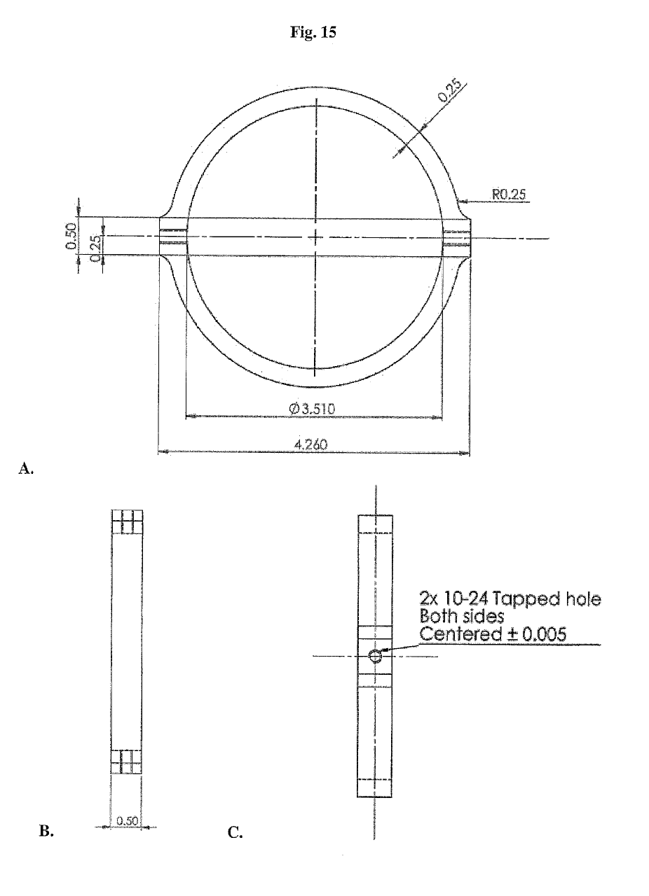

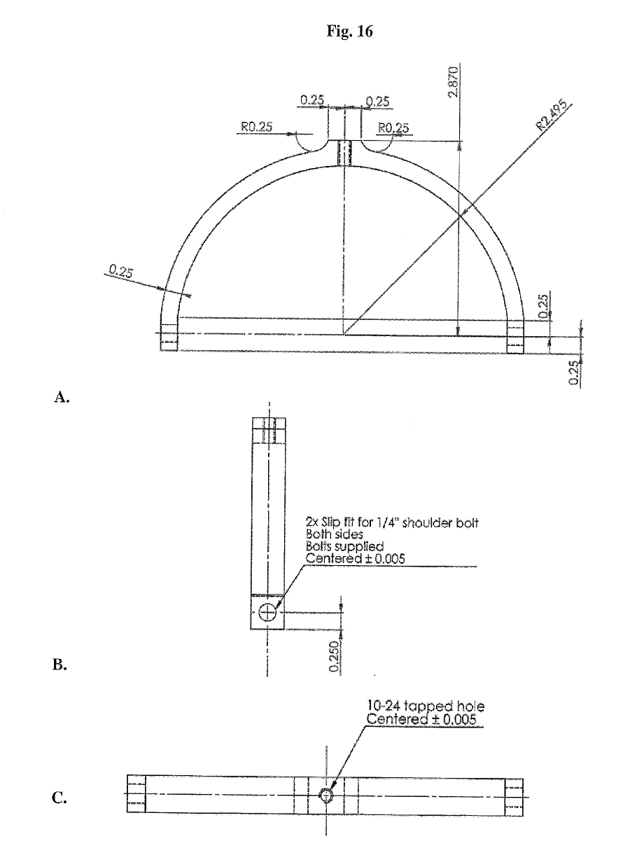

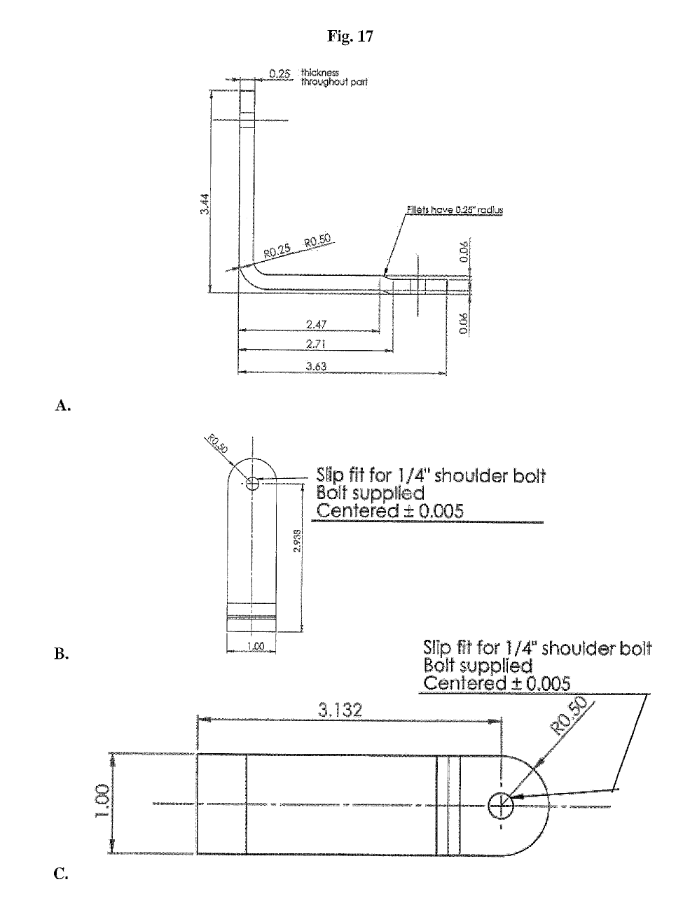

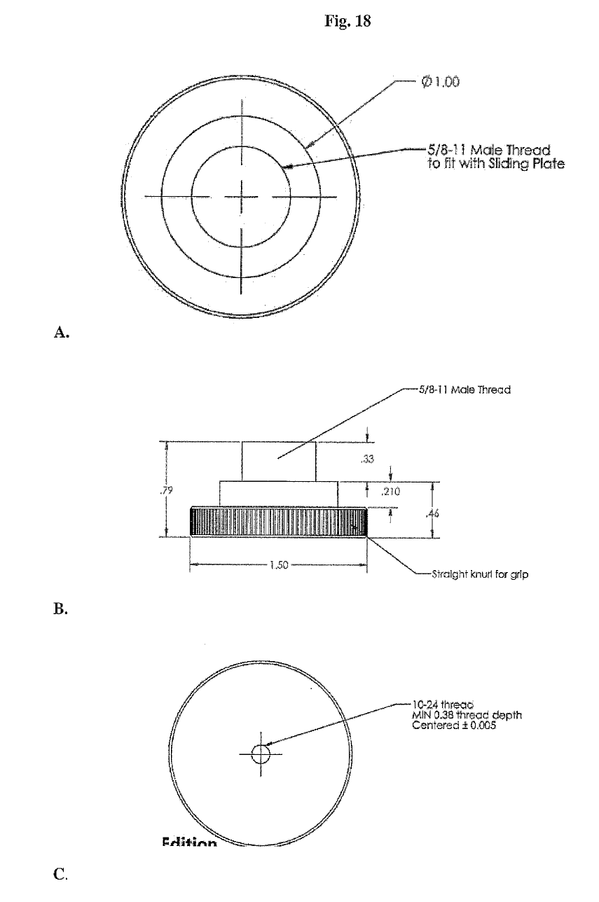

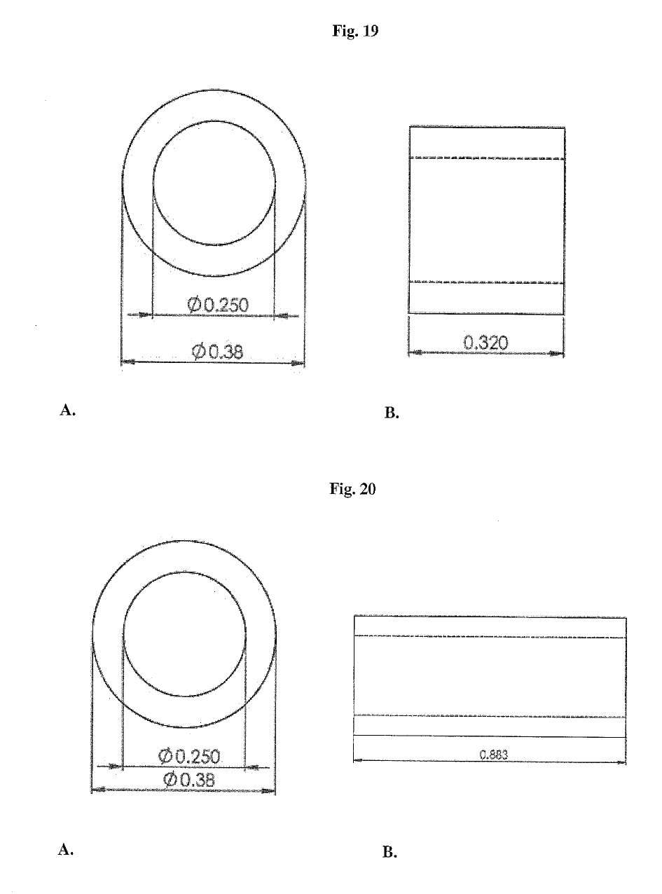

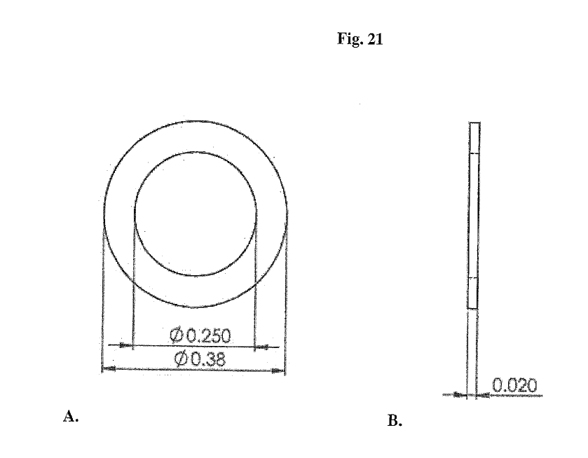

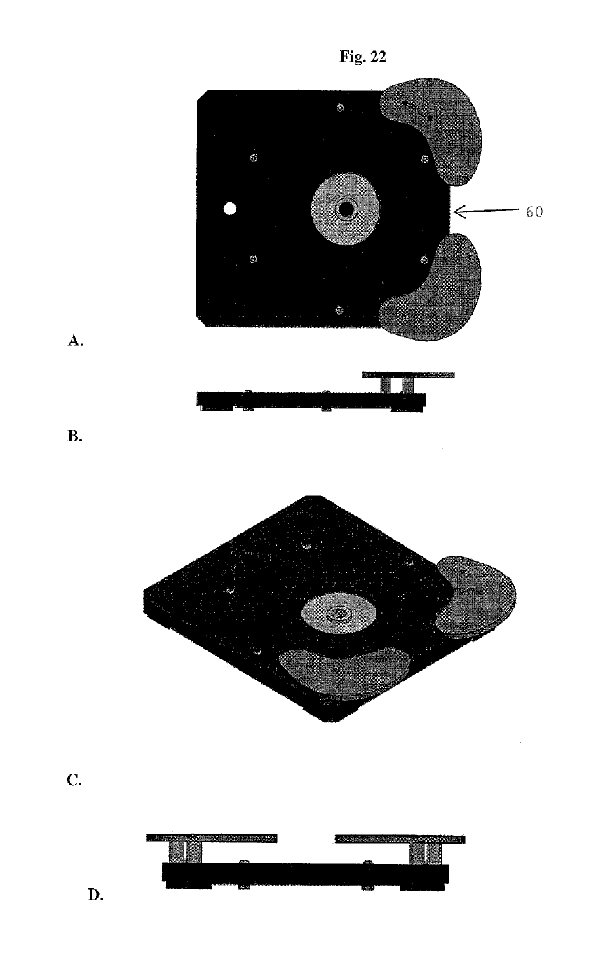

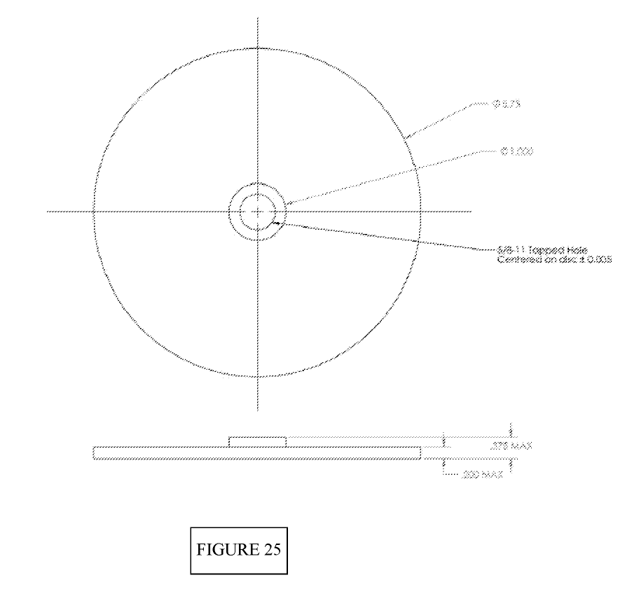

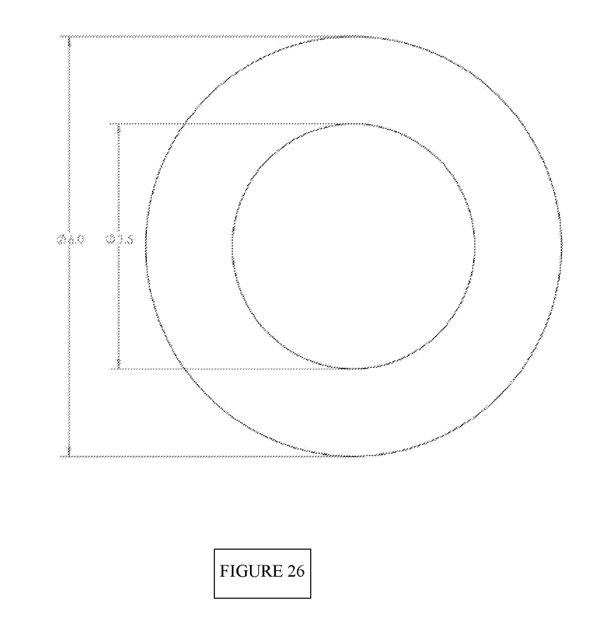

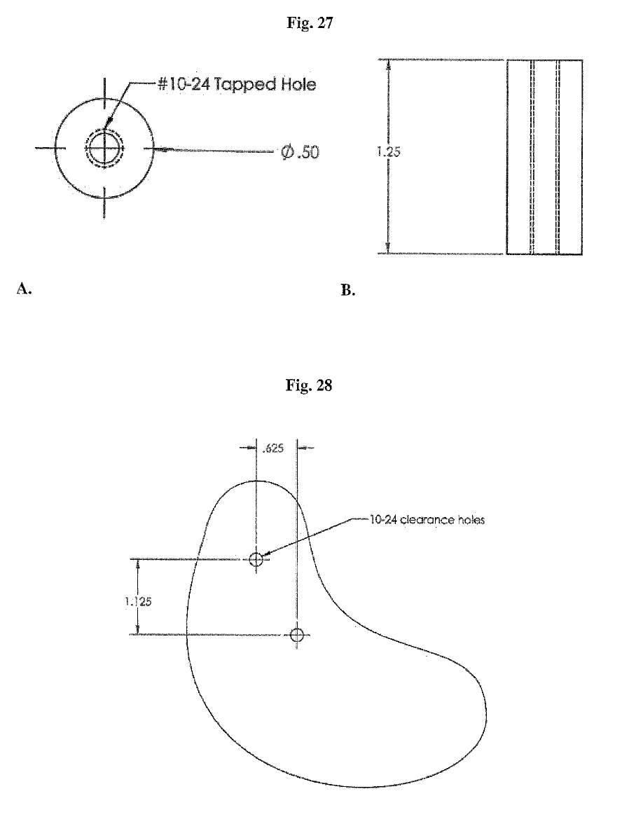

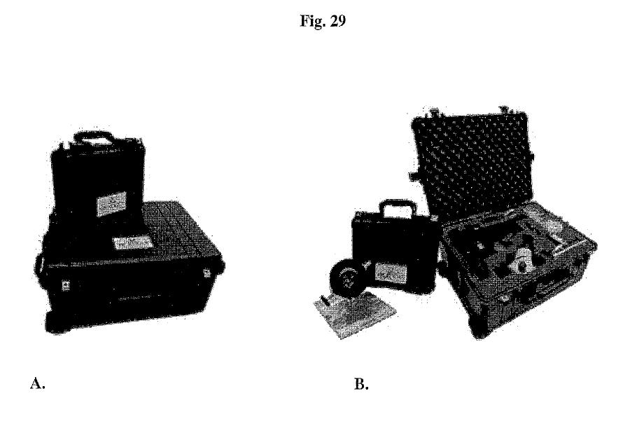

Schematics for gimbal embodiments are shown in FIGS. 13 and 14 as illustrations (A) and schematic diagrams (B) with corresponding exemplary materials shown in Tables 2 and 4, with labeled parts for the figures shown in Tables 3 and 5, respectively for these figures. Thus, a gimbal rotational system, as a module docking station, for moving about on each of 3 axes is described in exemplary figures, diagrams, and exemplary engineering diagrams showing parts, i.e. FIGS. 15-28. Unless otherwise indicated, engineering diagrams show dimensions of parts as inches.

This design maximized the visibility of the module and provided a range of motion greater than would be seen during a surgery. Thus providing a rotational range of motion that replicated a surgeon's change of perspective during surgery. The gimbal can easily be rotated and adjusted to provide its user with the ideal viewing angle. Friction is used to maintain the orientation of the gimbal, in one embodiment.

In one embodiment, the friction for exemplary gimbal (30) was generated from the shoulder bolt compressing Delrin spacers against the aluminum gimbal rings. In one embodiment, a torque of approximately 3.5 inch-pounds was needed to overcome the static friction. This static friction was enough to hold the practice module stationary while in use, but not enough to burden the user as they move the gimbal orientation using two adjustment knobs (g11), and in some embodiments by additionally moving the quarter gimbal ring attachment (g2). In one embodiment, the quarter gimbal ring attachment (g2) is moved by the user by pushing or pulling one or the other of the two adjustment knobs (g11), see FIG. 14B.

Therefore, in one embodiment the rotational holder for a module, i.e. a rotational module docking station gimbal wherein a module is inserted or docked within the full ring (g1), has the capability to rotate on each of three axes thus translating (i.e. providing) the capability for the module to rotate on each of three axes.

An exemplary gimbal (20) illustration is shown in FIG. 13A, with a matching schematic in FIG. 13B, exemplary parts are described in Table 2 with labeled parts described in FIG. 13 as shown in Table 3.

TABLE 2
Exemplary Gimbal Rotational System (20) as one embodiment.

| Material | Quantity - size | Cost per Gimbal | | Material Cost | |
|---|---|---|---|---|---|
| Steel Ball Bearings | 2 | $5.30 | ea | $10.60 | |
| Snap Rings | 3-4 | $0.789 | ea | $7.89 | (100 pkg) |
| Stainless Steel Shaft ¼″ | 3x | $0.70 | per inch | $8.40 | (12″ length) |
| | approximately | | | | |
| | 1″ Shafts | | | | |
| Stainless Steel Shaft ½″ | 1x | $1.63 | per inch | $9.76 | (6″ length) |
| | approximately | | | | |
| | 1″ Shaft | | | | |
| ½″ thick Aluminum (3rd rings) | 5 in² | $0.77 | per in² | $23.10 | (5″ × 6″) |
| 54″ thick Aluminum ((1st & 2^{nd} | 30 in² | $0.47 | per in² | $13.96 | (5″ × 6ⁿ) |
| rings) | | | | | |

| | | | | |
|---|---|---|---|---|
| Bronze Sleeve Bushings | 2 | $0.43 | ea | $0.86 |
| | | $36.16 | per gimbal | $74.57 |

TABLE 3
Exemplary Gimbal Parts Assembly for one
embodiment (20), shown in FIG. 13B.

| ITEM | | |
|---|---|---|
| NO.* | PART NAME | QTY. |
| 1 | Full Ring | 1 |
| 2 | Half Ring | 1 |
| 3 | 91259A546 | 2 |
| 4 | spacer_1 | 2 |
| 5 | 96697A500 | 8 |
| 6 | spacer_2 | 2 |
| 7 | Quarter Ring | 1 |
| 8 | 912S9A534 | 2 |
| 9 | Base | 1 |
| 10 | Foam Insert | 1 |
| 11 | Container Ass_Jan IS | 1 |
| 12 | knobs | 2 |

*These part numbers refer to parts in FIG. 13B.

An exemplary gimbal (30) illustration is shown in FIG. 14A, a matching schematic in FIG. 14B, parts as described in Table 4 with labeled parts described in FIG. 14B as shown in Table 5.

TABLE 4
Exemplary Gimbal Assembly diagrams
in FIG. 14A: Raw materials.

| Material | Quantity | |
|---|---|---|
| 1″ Thick 6061 Aluminum (quarter ring) | 30 | in² |
| ½″ Thick 6061 Aluminum (full and half rings) | 30 | in² |
| 1½″ Diam. Aluminum rod | 6 | inch |
| 1½″ 10-24 Shoulder bolts | 2 | |
| ⅜″ 10-24 Shoulder bolts | 2 | |
| Delrin tubing OD ⅜″ ID ¼″ | 36 | inch |
| Spring Washers | 10 | |
| Foam Padding | 1 | sheet |

| | |
|---|---|
| Complete Sliding Plate System | 1 |

TABLE 5
Exemplary Gimbal Parts Assembly for one
embodiment (30), shown in FIG. 14B*.

| ITEM | | | |
|---|---|---|---|
| NO. ** | PART NUMBER | DESCRIPTION | QTY. |
| 1 | Full Ring | Inner ring that supports modules as | 1 |
| | | cassettes and cartridges; provides | |
| | | first rotational movement | |
| 2 | Quarter Ring | Quarter ring connects gimbal to | 1 |
| | | base and provides 3rd rotational | |
| | | movement | |
| 3 | Half Ring | Half ring provides 2nd rotational | 1 |
| | | movement | |
| 4 | spacer_3 | Outer spacer to provide friction | 4 |
| | | lock | |
| 5 | Foam insert (has a | Aids in holding module onto | 1 |
| | sticky back for | gimbal | |
| | attaching to gimbal | | |
| 6 | Interface_Part | Interfaces gimbal between | 1 |
| | | stationary and XY bases | |
| 7 | 91259A546 | 1½″ shoulder bolt 10-24 thread | 2 |
| 8 | spaceM | Inner Spacer | 2 |
| 9 | spacer_2 | Outer spacer to provide friction | 2 |
| | | lock | |
| 10 | 91259A534 | ⅜″ shoulder bolt 10-24 thread | 2 |
| 11 | 94052A14I | Plastic machine screw knobs | 2 |
| 12 | 96697A500 | Wave Spring washer | 10 |

** These modified part numbers are used herein in reference to part numbers of a gimbal unit i.e. as g1, g2, etc, unless otherwise specified.

An exemplary stationary base for a gimbal unit is shown in FIG. 3 where the gimbal unit is attached to or shows a stationary or fixed base (40), see a view of a separate gimbal unit (left) and the corresponding stationary base (right) in FIG. 3C. In one embodiment, the rotational gimbal unit is attached to a stationary base by screwing the unit into the base. An additional movement as coarse planar motion may be provided to the gimbal unit by sliding the stationary base on a surface, i.e. a table surface supporting the microscope.

C. Planar Motion Systems: Maneuverable Base.

Translating a motion of the module attached to a rotational gimbal docking unit, into planar movement may be desired. Thus in some embodiments, additional systems and/or parts capable of movements on one or two planes is provided beyond the capability for adjusting the angles of the modules within and by the gimbal system. This type of control provides a finer level of control than by merely sliding the stationary base, which depending upon the surface may move in jerky movements, as it alternatively sticks to the surface then slides, or slides too quickly without stopping. Small movements of a stationary base viewed under a microscope translates into huge movements of the image to the user. Therefore, in order to move the module using planar movements under fine control under a microscope, in one embodiment, the rotational gimbal docking unit has planar adjustment or planar movement provided by a maneuverable base. Therefore, a docking station gimbal unit base is a maneuverable platform that includes but is not limited to a spring base, a sliding base, and the like.

1. Planar Adjustment.

In addition to adjusting the angle of the module, it would be advantageous to be able to center the module within the field of view of the microscope. Various ideas to achieve this planar adjustment were initially considered (i.e. XY stages, plate-on-plate, rack-on-rack), but after developing several prototypes it was concluded that the best design should encompass a low profile and simple mechanism. A low profile maintained the microscope at a comfortable working height, while a simple mechanism helped reduce costs and risks.

a. Sliding Carriage Platform.

The design that best fits these criteria is the “R-Theta” design concept, shown in FIG. 7 (Left). This design includes, but is not limited to, a pivot-point, two parallel rails, and a sliding carriage (s5). For example, the module and gimbal system may sit on a carriage, which can slide smoothly along the rails. The carriage also moves side-to-side, as the rails rotate about the pivot joint. The combination of radial and angular displacement of the carriage allows for any part of the module to be centered within the microscope's field of view.

The following Table 6 shows exemplary materials for producing a sliding carriage platform (50), i.e. system, for planar motion of a gimbal (20) and thus for a module contained within a gimbal.

TABLE 6
Planar Motion System: Sliding Carriage Platform, 50.

| No. | Product Description | Quantity | Price Per Unit | | Total Price |
|---|---|---|---|---|---|
| 1** | Igus Drylin AWM Shaft 10 mm Diameter | 1 | $0.91 | per inch | $7.30 |
| | 8″ Length | | | | |
| 2 | Igus Drylin W 10 mm Bearing | 4 | $5 | ea | $20.00 |
| 3 | Ground Steel Shaft ¼″ Diameter 12″ | 1 | $0.37 | per inch | $4.54 |
| | Length | | | | |
| 4 | SAE 841 Bronze Flange Sleeve Bearing | 2 | $1.22 | ea | $2.44 |
| | ¼″ Diameter | | | | |
| 5 | White Delrin Rectangular Plate 5″ × 12″, | 1 | $0.315 | per in² | $18.90 |
| | ⅝″ thick | | | | |
| 6 | Acrylic Plate 12″ × 12″, ¼″thick | 1 | $0.113 | per in² | $16.36 |
| 7 | Thumb Screws ¼″-20 Thread, 2″ Length | 1 | $1.616 | ea | $8.08 |
| 8 | Toggle Clamp | 1 | $5.83 | ea | $5.83 |
| 9 | Socket Screws 8-32, 1″ long | 6 | $4.72 | ea | $28.32 |

| | |
|---|---|
| Total | $111.77 |

**The numbers here correspond, in part, to parts shown in FIG. 7, also referred to herein as s6, s8, and the like.

b. Locking Mechanism for Sliding Carriage Platform.

In one embodiment, the gimbal (20) may be locked onto the location of a planar adjustment system. In one embodiment, a toggle clamp may be mounted to the carriage. For example, the toggle clamp (s8) may push down on the base and use friction to stop any radial or angular displacement. This solution may provide a single locking mechanism, which is preferable over using two thumbscrews to individually lock the carriage and pivot joint. See, FIG. 7 (Right).

However, after further testing, it was determined that the best planar adjustment system, i.e. planar motion for the modules, was provided by an X-Y (XY) platform (system) over the carriage platform. Details on an X-Y system are as described in section 2, below.

2. X-Y Planar Adjustment: Spring Base.

In addition to the sliding carriage planar system described above, another planar adjustment system (60) (as a spring assisted sliding plate mechanism, i.e. spring base) was developed for use in providing movement for the module docking station gimbal (30). These additional movements translate into providing additional movements of the modules when attached (inserted) into the docking station, i.e. into the full gimbal ring (1). Although this system is described for providing X-Y movement, this system also provides 360 degree of planar movement to the gimbal unit, and thus to the module, within a specified circular area of the stand, i.e. p12. Engineering diagrams showing exemplary aspects of parts of the spring base (60) are shown in FIGS. 8, and 22-28.

After several design iterations that included an X-Y stage (i.e. base) and a rotating linear track (i.e. including a design for a sliding carriage platform (50) as described herein), it was determined that the best comparative design had a low profile and featured a simple mechanism that was controlled using the same “adjustment knobs” as the gimbal system. Additionally, a low profile was less interfering with the working distance of the microscope thus optimizing the maneuvering space by the user. As on example, a lower working distance negatively influenced the viewing height. Further, a simple mechanism that could be easily controlled through the “adjustment knobs” (11) allowed the users to make adjustments without having to remove their position while viewing the image through the eyepieces of the microscope.

One embodiment of a planar adjustment system (60) is a spring base comprising; a boom stand base (b1), that in one embodiment is a stand alone base without an attached boom stand, and in another embodiment a base attached to a boom stand, wherein the sides of the base form a cavity underneath the base, a spring plate made of Delrin (b3), and a sliding aluminum plate (b6) to which the gimbal system was attached by an interface piece (g6). A cavity was machined out of the base to form (b1) and the Delrin spring plate (b3) was attached using 6 screws (b9) and 6 springs (b10). The Delrin spring plate functions as a false bottom of the stand that moves up and down, depending upon the pressure applied to the attached gimbal (30). The aluminum sliding plate (b6) was able to freely slide on the Delrin plate (b3) in the X-Y plane. In its rest state, the springs pressed both the Delrin bottom and aluminum sliding plate against a rubber gasket (b2) situated on the base (b1), locking the sliding plate in position. The sliding plate (b6) was released by pushing down on the adjustment knobs (11), which compressed the springs and lowered the Delrin plate. The sliding plate was then able to slide freely over the Delrin surface in the X-Y plane. Upon releasing the pressure on the adjustment knobs the springs force the sliding plate back up against the rubber gasket, locking it in place. FIG. 8 depicts the cross-section of one embodiment of an X-Y planer system (60) as a spring-loaded base.

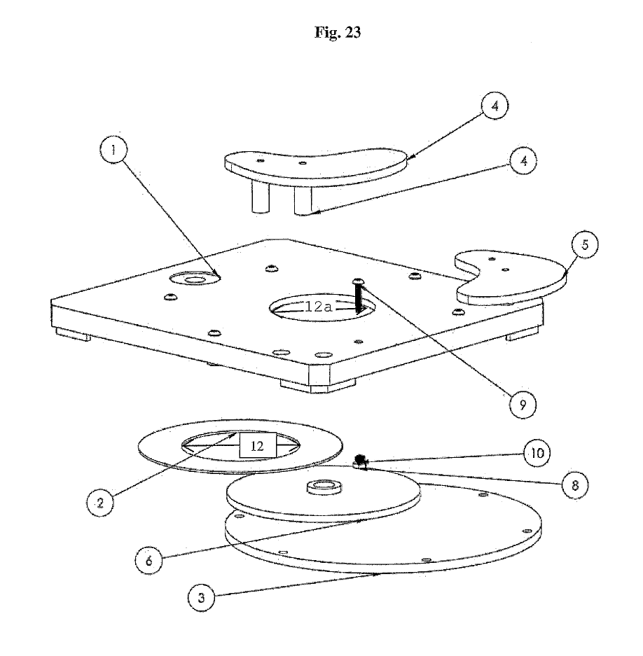

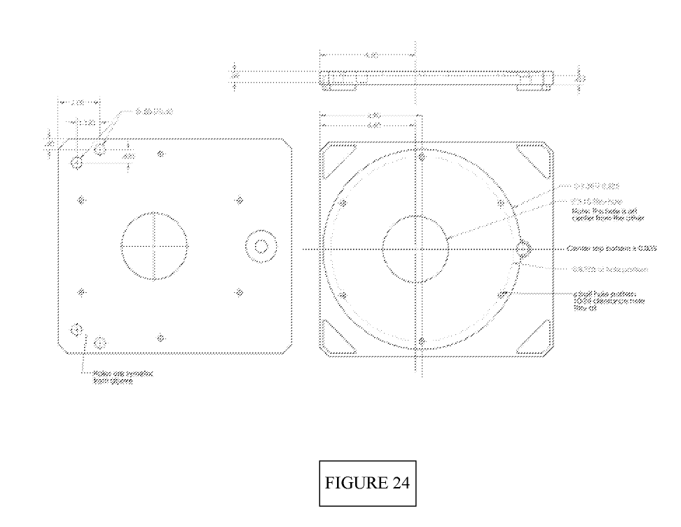

An exemplary break out diagram of a spring base (60) is shown in FIG. 23 with an overview shown in FIG. 24. In one embodiment the stand has wrist rests. An exemplary diagram of a stand with wrist rests is shown in FIG. 24. An exemplary break out diagram of a spring base (60) with wrist rests is shown in FIG. 23.

In one embodiment, the system comprises a platform comprising a planer motion system (60) and a gimbal system (30), including but not limited to materials, sizes, quantity of material used per unit, etc. See, an exemplary Planar Motion System, described in Tables 7-8.

TABLE 7
Planar Motion System: XY system assembly:
Exemplary Raw materials.

| Material | Quantity |
|---|---|
| ¼″ Thick Black Delrin Plate | 144 in² |
| ⅜″ Thick 6061 Aluminum Plate | 64 in² |
| Steel Compression Springs 0.30″ OD | 6 |
| Type 18-8 Stainless Steel washers 0.44″ OD | 6 |
| 1/16″ Thick Neoprene Rubber Pad | 36 in² |
| Alloy Steel Button-head Screw Cap 10-24 Thread | 6 |
| Steel Hex Nut 10-24 Thread | 6 |
| Compete Sliding Plate System | 1 |

TABLE 8
Planar Motion System: XY system assembly:
Labeled parts corresponding to FIG. 23***.

| ITEM | | | |
|---|---|---|---|
| NO. | PART NUMBER | DESCRIPTION | QTY. |
| 1 | BoomStand | Amscope boom stand | 1 |
| 2 | Rubber_friction | Rubber gasket provides friction to | 1 |
| | | lock sliding plate | |
| 3 | XY_BottomPlate | Base plate that pushes sliding plate | 1 |
| | | for friction lock | |
| 4 | WristRest_Left | Wood base | 1 |
| 5 | WristRest_Right | Wood base | 1 |
| 6 | Sliding Plate | Sliding Part that enables XY | 1 |
| | | translation | |
| 8 | 90480A011 | 110-24⅛″ thick nut | 6 |
| 9 | 91255A246 | ⅞″ 10-24 machine screw | 6 |
| 10 | 9657K265 | Compression Spring | 6 |
| 11 | 92141A011 | Washer | 6 |

Item No. 12 - inside diameter of rubber gasket.
Item No. 12a - inside diameter of the opening in the base plate surrounding the sliding plate 6
***These part numbers correspond to part numbers on a spring base shown in FIG. 23 and are referred to herein as b1, b2, etc.

The diameter of opening 12, alternatively 12a, determines the range of motion of sliding plate 6 and thus determines the range of sliding motion of a gimbal unit. The diameter of the circular area may range from 1-6 inches.

D. Interchangeable Module Design: Module Subsystem.

The system may include at least one, interchangeable module, each with different tasks or games for the user to practice their surgical skills and dexterity. The interchangeable modules may generally fall into three different categories, for example: i) medically accurate tasks; ii) specific dexterity games; and nonspecific “sand-box” style modules. FIG. 5 provides an overview of the overall design of an interchangeable module. FIG. 4 shows an overview of exemplary modules, left module showing an example of a construction or dexterity module (71), the right module showing a surgical skills module for suturing blood vessels (72). The construction module has miniature blocks for building a structure, for example a Nanoblock® structure. The surgical skills module has attached springs for holding synthetic blood vessels and the synthetic blood vessels.

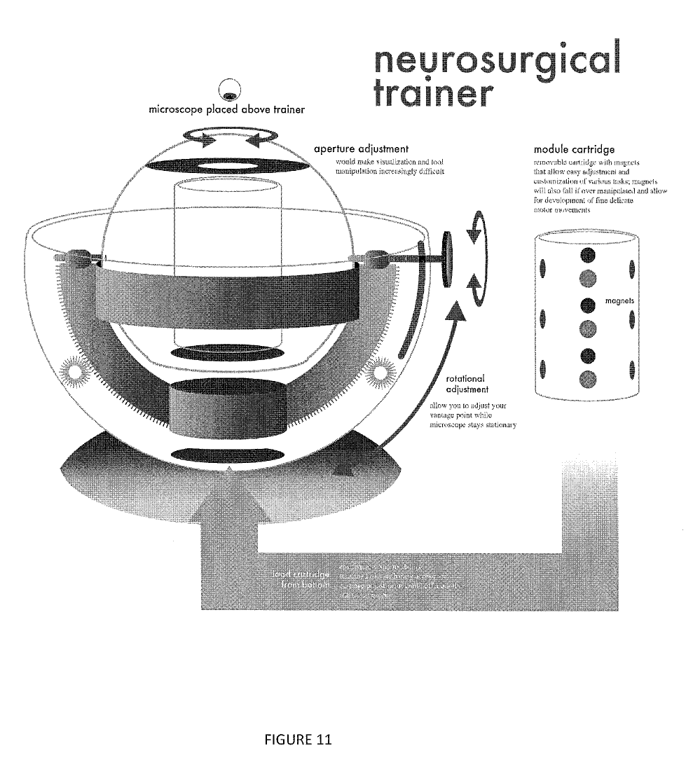

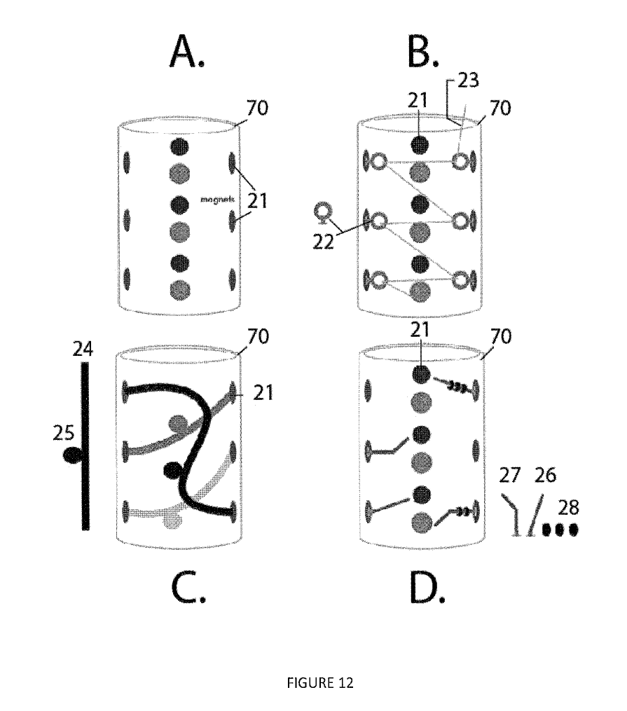

Modules may also provide surgical skills training in the form of module cartridges (70). A schematic of a gimbal containing a module cartridge is shown in FIG. 11. FIGS. 11 and 12 show exemplary module cartridges for use with performing such tasks, see Table 9.

1. Size:

The modules may be housed in a standardized transparent or translucent cylinder container approximately 75 mm in diameter and 75 mm tall. In some embodiments, the cylinder container is an interchangeable cassette for the module. Thus, modules are built inside of or placed inside of a module cassette. The size of the container provides sufficient room to house and replicate a large variety of surgical tasks. This size was determined iteratively through user testing. In some embodiments, the module is a cartridge (70) that provides a specific task. In some embodiments, the module cartridge has magnets (21) embedded in the sides. See, FIGS. 11 and 12, and Table 9.

2. Lighting:

The container may have a threaded lid (80) that may house a ring of LEDs light to illuminate the modules. This lighting system may be battery powered and rechargeable. The lighting from the lid provides sufficient operational luminosity and eliminates shadow areas thus, ring LEDs were a good solution. FIG. 6A is a picture of the prototype of this design (80). FIG. 6B shows details of integrated lighting, a switch for turning on and off the lighting. FIG. 6C shows two embodiments for providing power for the lighting, batteries and plug in power.

3. Tool Apertures:

The lid of the module may allow a variety of different “tool apertures” or “apertures” (90) to be used in order to restrict the entry point, and provide a greater challenge for users using the device. These “tool apertures” may most likely snap into the lid, but there is a possibility to use a mechanical iris, or some other adjustable aperture. By adjusting the aperture size, it would alter the degree of difficulty. For example, by decreasing the size of the aperture, it would make visualization of the module and corresponding tool manipulation increasingly difficult. Exemplary snap-fit apertures are show in FIG. 5.

4. Retractor Bars:

Placing and using retractor bars (100) is an important task that neurosurgeons often rely upon during surgery. Thus, some modules may require the user to use retractor bars to move simulated tissues out of the way. These retractor bars may be able to be attached to the lid of the cassette or module.

E. Training Module Objectives: Modular Tasks and Surgical Training Modules.

Modules are contemplated for surgical simulation and dexterity skills under broad categories: medically accurate tasks, such as simulated surgery, and specific dexterity skills as games and nonspecific “sand-box” style modules, described below. Thus, in one embodiment, a module may comprise a training cartridge designed to practice micro-suturing, the other may be more of a fun game or “sandbox” style activity to allow the user to practice and test their dexterity. In one embodiment, a module is reusable, such that a module is partly or fully reusable with synthetic materials. In another embodiment, a module is disposable, such that it may contain organic specimens or organic tissues.

Moreover, training modules may be developed to serve as a reference for a particular surgical scenario as encountered in the operating room. In another contemplated embodiment, retractor bars will be added to the system in order to simulate pulling back layers of tissue during an operation. In another contemplated embodiment, modules will incorporate a pump system to simulate blood flow, for increasing complexity of the training and to provide more realistic practice scenarios, including but not limited to repairing aneurysms, including brain aneurysms, and anastomosis surgery for repairing blood vessels or rerouting blood vessels. Furthermore, modules may be used to compare effectiveness of surgical instruments.

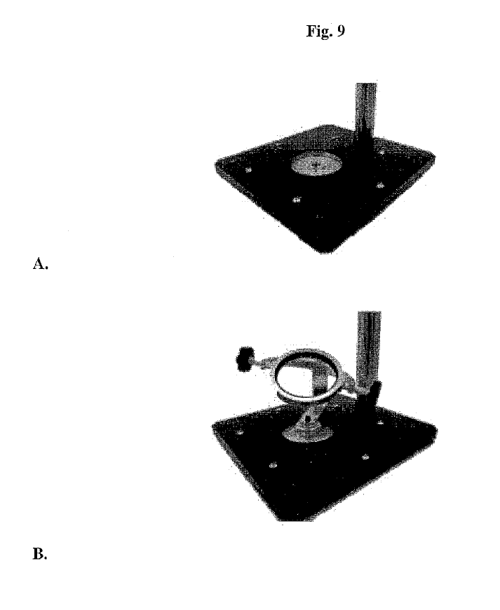

Training modules as cassettes and cartridges were developed and contemplated for use in order to demonstrate the functionality of the training system. Exemplary modules were inserted into a gimbal unit, see, for example, FIG. 11 schematic, and placed under a microscope using a stationary base (FIG. 3) or spring base, i.e. maneuverable base, as shown in FIGS. 8-9.

1. Surgical Simulation: Modules and Training Cartridges.

Modules that can realistically simulate specific surgical procedures may also be extremely useful for the users to enhance their surgical abilities. These tasks can be designed to be a quick refresher or to warm-up before surgery, or they can be used to fully replicate a medical procedure. These modules can be developed to encompass a wide variety of surgical fields including, but not limited to: Neurosurgery, Orthopedics, Pediatrics, Plastic/Maxillofacial, Vascular, etc. Modules may provide a faster and more optimal way to practice a specific surgical skill such that the user can optimally use training time by focusing on the module surgical skill or practice task without the longer set-up times when using live animals or taking the time for obtaining and setting up large pieces of cadaver practice tissues. Further, the use of medically accurate modules may be designed to simulate surgical tasks that may be encountered during surgery. For example, some modules may be designed for general surgical skills such as: cauterizing, suturing, and replantation, i.e. microsurgery associated with reattaching a body part, such as a finger, hand, or for reattaching adjacent tissue where the intervening tissue was removed, however modules are not limited to providing tasks for achieving these skills.

Specific suturing models may include but are not limited to microvascular anastomosis for making surgical connections between blood vessels, as when repairing injured or cut blood vessels (i.e. using a module containing blood vessels or microvascular type blood vessels and holding springs, FIG. 4, right, or a Suture and hoop cartridge, where suture thread (23) and a plurality of magnetic hoops (22) in module cartridge (70) provide a module for practicing delicate suturing, FIG. 12B and Table 9. Hoop magnets are capable of rotating in response to pressure from surgical suturing and capable of falling off the side magnets when too much pressure is applied to the hoop.

Modules may be simple (i.e. basic), for examples, construction modules for using miniature blocks to build structures, with more advanced or complicated modules, such as simulated surgical modules, designed to further develop or improve upon (i.e. build on) basic skills. For an example of a more advanced module, in one embodiment, the module may comprise a training cartridge designed to simulate blood flow. By using such a setup, the neurosurgeon may be able to practice & test their suturing and other relevant skills. In particular, practicing or improving skills in the presence of moving fluids similar to fluids inside of blood vessels. Such a module might provide instant feedback of simulated surgical success by either stopping fluid escape when suturing was successful to repair a blood vessel or suture two blood vessels together or by allowing fluid escape when inappropriate cuts or needle stabs were made in the simulated blood vessels. In one embodiment, exemplary 3D Med Synthetic Blood Vessels are contemplated for use.

Complex surgical modules may be in the form of artificial surgical simulations. Such contemplated modules may provide training tasks for attaching implants or attaching areas of skin where tissue was removed such as procedures conducted during plastic surgery wherein cut ends of microvessels are attached, for cauterizing blood vessels, and the like. Others may be developed for very specific procedures such as: An Anastomosis, a Carotid Endarterectomy or an Aneurysm clipping. Some of these modules may be designed to be used once, possible with fresh or preserved tissues from animals. Some may also be made of synthetic tissues and may be fully reusable, or reusable with some replaceable parts. The challenge of these tasks may require the use of retractor bars, or require the user to move tissue or other obstacles out of the way to accomplish the required tasks.

Examples of a module for aneurysm clipping skills, such as required during brain aneurysm repair are embodiments of aneurysm modules. One embodiment of an aneurysm module may comprise synthetic microvessels, such as found in the brain, a titanium aneurism clip, for example a Sugita clip. A user is assigned a task of clipping the aneurysm to repair the microvessel. For a more realistic surgical simulation module, synthetic blood microvessels may contain a fluid, such that a timer is started at the beginning of the repair for a specified time, after which fluid begins to leak out of the microvessel. In another embodiment, after a set time if the simulated aneurism is not repaired properly it will rupture leaking fluid.

Examples of a carotid endarterectomy refer to an operation during which a vascular surgeon removes the inner lining of the carotid artery to thin or repair a damaged area, in particular to remove plaque from the artery to restore blood flow. Thus an endarterectomy module provides materials for simulating the inside of an artery containing an area of plaque, as one example.

FIG. 13 is directed to an illustration of the microsurgical training system according to one embodiment of the invention. FIG. 14 shows examples of training cartridges. See, Table 9.

TABLE 9
Exemplary module training cartridges for neurosurgery.

| 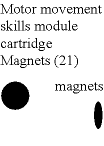 | 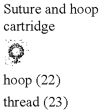 | 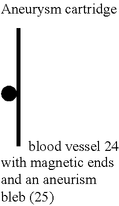 | 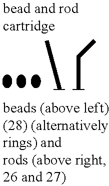 |
|---|---|---|---|
| removable cartridge | magnetic hoops can | magnetic ends of the | Magnetic rods are |
| with magnets (21) | be inserted at any | blood vessels would | contemplated as |
| that allows easy | rotation to allow | allow various angles | customized: trainer |
| adjustment and | complex | to attract practicing | would aim to grasp |
| customization of | manipulation of | clipping aneurysms; | and place beads |
| various tasks; | needle and suture. | ideally the blood | without losing rod's |
| magnet will also fall | | vessel replica would | magnetic grip |
| if over manipulated | | be made of material | Other contemplated |
| and allow for | | stimulating actual | games include |
| development of fine | | vessel to allow | dual closure |
| delicate motor | | breaking with over | micro vessel |
| movements. | | manipulation. | anastomosis |

As additional examples, a module may be designed for laparoscopic surgery, a surgical technique in which operations are performed through small incisions. One example of a laparoscopic module would be for micro-laparoscopic manipulations through various size openings. In one embodiment, retractor bars may provide the capability to change the size of the openings into the module. In one embodiment, a camera and viewing screen would be placed next to the module in order to follow the progress of the micro-laparoscope on a video screen or to record the session. In one embodiment, a buzzer or light would signal the successful manipulation of the simulated target in the module. In another embodiment, a buzzer or light would signal a detrimental contact within the module.

Furthermore, a complex surgical model may contain an artificial organ. As one example, a simulated organ may be a part of an organ or an entire organ. As one example, a simulated organ might be a model of skin, containing epidermis, dermis and microvessels. Such an artificial skin module might be used for teaching plastic surgery skills. In another example, an artificial organ for surgical simulation may be a heart comprising valves and blood vessels. Such an artificial heart module might be used for teaching valve repair skills. In a further example, a fluid may be pumped through the artificial organ for simulating blood during surgery. Such an artificial blood vessel fluid module might be used for teaching blood vessel repair skills. In another example, an artificial organ may be a part of a brain. Such an artificial brain module might be used for teaching advanced aneurysm repair surgery skills. In another example, an artificial organ may be an eye, or a part of an eye. Such an artificial eye module might be used for teaching cataract repair skills.

2. Games:

Dexterity skills modules may be in the for in of games including “sand-box” style modules. Game modules can be used to develop the very fine motor skills required to manipulate instruments under a microscope, in a manner that is both fun, repeatable and may be used to measure capability and improvement in dexterity and motor skills. Physical tasks or games may be useful for the users to develop their dexterity and skills of working under magnification. A wide variety of these modules may provide challenges to the surgeons, and allow them to practice using their tools, in a fun yet relevant manner. There may be some modules that have a very specific goal to be achieved, like sorting small beads, or navigating a maze.

Dexterity games with a distinct and repeatable goal will allow the users to improve and track their skills progress, including but not limited to quality of task and competing against the clock (timer) or against times of other users, in order to achieve a better or higher score. One example of surgical training may be accomplished using a module containing defined movements where a light or buzzer is activated when there is a movement detrimental to a successful surgical skill.

3. “Sand-Box” Style Modules.

There also may be “sand-box” style games where there is no particular goal, but just a number of small pieces that can be manipulated by the user. The game-type modules would most likely be reusable and resettable, but may also have single-use parts or components. These sand-box modules may be in the form of construction tasks, which provides the users a means to use dexterity exercises for warm-up before a surgery or to hone their dexterity skills. Further these modules are contemplated for use in establishing skill benchmarks or for testing new surgical instruments. Further, construction type sand-box modules are contemplated for use in combination with using surgical tools in order to challenge the ability of medical practitioners' ability to move and manipulate small objects with specific surgical tools. For example, construction modules are contemplated for use in combination with using surgical tools in order to challenge the ability of medical practitioners' ability to move and manipulate small objects using specific surgical tools.

With no specific goal or way to “beat” the game, these construction type modules would provide a very high replay value. In some embodiments, construction may be timed as a means of evaluating dexterity. As one example, modules may include construction tasks, such as using miniature building blocks for building structures inside of a module using surgical tools such as forceps, retractors, etc. while looking through the optical system and viewing an image of the parts and structures while assembling them. A Nanoblock® construction module was made in order to provide a construction challenge. Using pre-existing Nanoblock® kits whose parts were placed inside of a module cassette of the present inventions, a specific challenge was provided for assembling a miniature Neuschwanstein Castle by testing the capability of a user using forceps under a microscope for assembling the Castle. Other examples of Nanoblock challenges that may be included in construction models for providing dexterity challenges include but are not limited to a WWII fighter, ladybug, etc., ((by Nanoblock® property of (Kawada Co. Ltd.)). Thus, “Sand-box” style games, games without a specific objective, can also be enjoyable and beneficial.

### II. System Assemblies.

During initial development, design concepts were made of foam and 3D printed ABS plastic. The first working prototypes conveyed the design idea and usability, but lacked precision. The subsystems have been manufactured in a machine shop and may be made out of 6061 aluminum, Delrin, and ground & polished steel shafts. Bearings and bushings may be incorporated to ensure that all the components in the systems move smoothly. The final product may be designed with a combination of white, black, and brushed aluminum finished parts. The part and cost breakdown for the planar and rotational adjustment systems system can be found in Tables 2 and 6.

A. Module Assemblies.

Modules may be assembled using additional parts, such as exemplary parts described herein and below. Additional parts are contemplated to use with further development of the training system, including embodiments of a MicroDex training system.

1. Modules and Cartridges.

Modules and module cartridges for a wide range of surgical simulations and for surgical skills or exercises are contemplated for use as part of a microsurgical training system. Examples of such modules are described herein. In some embodiments of the system, altering the location of module components may be necessary in order to optimize the relative distance between tools, microscope and the user, after loading modules into the rotational gimbal.

Further, relocation of components in or attached to the modules, such as changing the locations and/or numbers of the magnetic hoops, changing the location of magnetic synthetic blood vessels, with or without aneurisms, changing the location of synthetic blood vessels attached to springs, changing the distance between retractor bars, when present, is contemplated in order to provide increasing degrees of difficulty for challenges. Thus, in one embodiment, a retractor bar is added to the lid attached to a module. In another embodiment, the location of a retractor bar is altered for decreased visibility for increasing the difficulty of the task. In one embodiment, a distance between a module and the base of the stereomicroscope is altered for increased visibility. In one embodiment, a working distance is increased or decreased. In one embodiment, a field of view is increased or decreased depending upon the size of the module.

Additional use of microsurgical instruments with modules for a greater accuracy test for the functionality of the training device, for non-limiting examples, forceps, microsurgical scissors, needles, needle drivers, suturing thread, clips, aneurism clips, retractors, etc.

In one embodiment, a microsurgical instrument is added to the system. In one embodiment, the use of a microsurgical instrument in the system increases the accuracy and/or functionality of the training device and/or the modules. Additional components may be used to aid with specific types of dexterity motion exercises. Examples are provided herein.

2. Rotational Docking System Gimbal.

In some embodiments, training modules and training module cartridges are loaded into (i.e. placed into) a docking station that is the center of the rotatable adjustment, i.e. rotational gimbal ring (g1), i.e. rotational docking system gimbal. In one embodiment, a cartridge is loaded from the bottom. In one embodiment, spinning the cartridge within the docking area might provide an additional rotational aspect of the module. In another embodiment, a module is loaded through the top of the docking area, gimbal ring (g1). In a further embodiment, a foam ring insert attached to gimbal ring (1) holds the module in place during rotational and planar movements.

3. Timer.

In some embodiments, a timer may find use in achieving teaching, training or exercise goals. In one embodiment, a timer may be incorporated in the base (b1).

4. Lighting and Apertures.

Proper lighting is needed during microsurgery. Operating rooms are equipped with a tremendous amount of light equipment to ensure that the surgeons have plenty of illumination exactly where they need it. In contrast, early tests of the dexterity trainer revealed that ambient light of a typical room was not sufficient for viewing items in or on the gimbal unit, and that additional lighting should be included as part of a microsurgical training system, including a MicroDex training system. Typically, during a microsurgery operation, the main light source was housed on the bottom of the microscope itself, which in turn can cast shadows of the surgeons' hands and instruments. Overhead lamps are often used mitigate the effects of these shadows.

To eliminate the issue of shadows, the inventors incorporated an LED ring of lights into the module lid, see, FIG. 6. In one embodiment, a lid component for attaching to a module was designed for use in a room under a range of lighting conditions. In one embodiment, a MicroDex lid component was designed for use in a room under a range of lighting conditions. An embedded ring of lights has 24 high power LEDS and provides 360° of uniform lighting, eliminating the issue of shadows and dark spots. Various lighting temperature schemes were tested with a selection for using a cool-white light scheme. The LED lights are powered using either two (2) A23 12V batteries or through a 12V DC wall charger that connects to the lid with barrel connector. The two (2) A23 batteries are able to power the light for approximately one and a half hours before they need to be replaced. Therefore, a 12V DC wall charger is recommended for prolonged usage. In addition to housing the LED lights and batteries, the lid has the capability to increase the complexity of the dexterity challenges through the attachment of different sized apertures. The apertures are able to restrict the size of the opening to the practice module from 60 mm down to 30 mm in increments of 5 mm. This restriction helps replicate the spatial challenges that surgeons experience during an actual surgery. Further, the lid has an opening in order to accommodate light from the LED lights to enter the module, reflect from the module components for viewing by the user of the optical system.

F. Summary.

The inventors developed, tested and used a functional prototype and actual training system, as a MicroDex embodiment, (i.e. product) that met the needs of the users including medical practitioners.

### III. Exemplary User Manual.

The following describes exemplary steps that may find use as part of a User Manual. Figures referred to herein are contemplated for use as part of the manual.

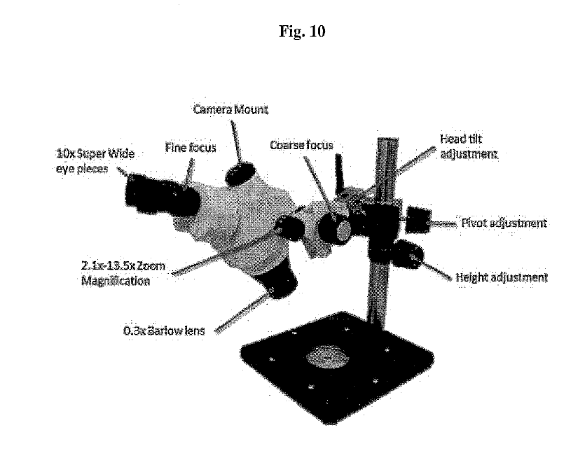

1. Setting Up Microscope & Stand.
The stereo microscope has two different focus controls, one on the eye pieces for fine focus adjustment and the other on the focusing rack for a coarser adjustment, as shown in FIG. 10.
A 0.3× Barlow lens was mounted to the microscope to increase field of view and working distance.
The microscope head connects to the base through a pinion joint via the boom stand. The pinion joint provides a tilt adjustment, whereas the coarse focus adjustment knob provides peripheral focusing. In some cases a clevis joint is used to attaché the microscope head. In this case, a clevis pin provides a tilt adjustment.
The boom stand facilitates the pivot action as well as the height adjustment.

2. Attaching Gimbal to a Base or Removing Gimbal from a Base.
In some cases, a gimbal does not have a base attachment in order to use on top of the microscope stand. In other cases, a gimbal is designed to be interchangeable with either a stationary base, a spring base as a boom stand base or as a stand-alone spring base for use without the microscope base.
Both bases, a stationary base and a spring base, feature female ⅝″-11 threads to attach the gimbal connector piece with compatible male threads by screwing the gimbal into the base.
The gimbal connector piece may be knurled in order to provide additional grip for attaching/de-attaching the gimbal from the base. FIG. 3C showcases the attachment design.

3. Attaching Lid with Lighting to Module.
The lids to the modules simply screw on clockwise and twist off counter-clockwise.
The LED lighting on the lid is powered by either 12V DC current from a wall adapter that plugs into the barrel port on the side of the lid, or by two A23 batteries contained within the lid. The batteries can be replaced by using a Phillips-head screwdriver to remove the panel on the underside of the lid as shown in FIG. 6B.
The power to the lighting is toggled with a 3-way switch on the side of the lid as shown in FIG. 6A-C: The “I” position is wall power, the “II” position is battery power, and the “O” position is off, see switch on lower left side of FIG. 6B.

4. Inserting Module into a Gimbal.
The modules are designed to easily slip into the gimbal (i.e. gimbal docking area ring (1) in FIG. 14B) and be held in place by the foam pad (5) on the inside of the gimbal ring. The modules can be removed by pulling up on the module with slight pressure or a twisting motion.

5. Rotational & Planar Adjustments.
Adjustments of a module incorporates 5 degrees of freedom, i.e. 3 rotational (gimbal) and 2 linear (spring base).
The gimbal system (FIG. 14B) can be rotated to any angle, and the knobs (11) provide an ergonomic contact point for adjusting the modules attached to gimbal ring (1) to change the view.
For planar adjustment, a spring assisted sliding plate mechanism was designed (60), shown in FIG. 8: Planar adjustment system, comprising a Delrin plate as a spring base (b3), an aluminum connector sliding plate (b6) and a microscope base (b1). To adjust the linear location, the user has to press down on the gimbal which pushes down the gimbal interface piece (g6), which compresses a spring (shown in FIG. 23 as 10) and allows the gimbal base, as represented by the interface piece to glide over the Delrin plate (b3) anywhere within the circle area cut into the base (b1), which surrounds the interface piece (g6) of the gimbal. On releasing the pressure, the friction from the springs presses the sliding plate against the neoprene rubber (b2) locking the planar position of the module.

6. Final Assembly.
The system can be set up on any table, desk, or other flat surface for use. It is recommended that the users sit in a chair with adjustable height so the microscope eyepieces can easy be positioned for comfort of the user.
Insert a module into the gimbal unit.
Adjust the eyepieces for the correct interpupillary distance to suit the user. Do this by moving the eyepieces closer together or farther apart until a single field of view is observed.
Use the coarse magnification adjustment knob to set at the highest magnification while observing the gimbal unit directly (not through the microscope) so that the microscope does not damage the training module. Then by looking through the eyepieces, bring a module image into focus by moving the coarse focusing knob bringing the microscope unit toward the user (away from the module), then focus by adjusting the fine focusing knob. See FIG. 10 for locations of focusing knobs.
Adjust the focus again if necessary by repeating the previous step for centering the image on a specific point of detail on the object under view, such as the center of a training module, or over the lowest point on the training module cartridge, located within the gimbal unit, depending upon the task for that module.

7. Protective Cases.
A large Pelican™ 1610 case stores the microscope, stand, gimbal system, a screw-on lid with integrated lighting, and three training modules, see FIG. 32.
A smaller Pelican™ 1400 case can be used to store the gimbal system with the secondary base, 2 practice modules, and a screw-on lid with the integrated lighting, see FIG. 32.

### III. EXPERIMENTAL

The following examples describe exemplary materials, exemplary contemplated evaluations of components and systems, exemplary contemplated methods for measuring improvement of surgical skills and capability to accomplish a surgical task as part of a surgical simulation, in addition to contemplated uses of the systems as educational systems.

### Example I

This example describes exemplary materials and sources for providing a microsurgical trainer component.

Materials described herein are for exemplary embodiments. In one embodiment, materials were used for providing a prototype system for testing. As examples of materials used and sourcing companies (in parenthesis) for testing prototyping materials of components and materials for providing training systems are described here, such as aluminum stock for gimbal, screws, bolts, etc. (McMaster Carr Elmhurst, Ill.); Electronic components and tools for modules (Sparkfun Electronics Boulder, Colo.); Synthetic blood vessels of varying diameter 2 mm, 3 mm and 4 mm. (3D Med, Franklin, Ohio); Foam padding and fabric for wrist rest (Jo-Ann Fabric and Craft, as one example in Boulder, Colo.); Protective Cases (Pelican Torrance, Calif.).

### Example II

This example describes exemplary evaluations and contemplated enhancements.

Testing of an exemplary training system by medical practitioners using a training module inserted into a gimbal unit allowed for intuitive and functional rotational adjustment of the module. Initially the microscope was mounted to an articulating arm stand or a boom stand then raised or lowered to position the module. However once the module parts were in focus, a preferred method by the users was to further adjust the position of the module rather than the microscope.

Users, including surgeons testing a training system module, wherein a module lid provided integrated lighting, found the lid lighting system adequate to clearly see the module materials. In particular, the lid lights were found to provide more than adequate lighting and without creating interfering shadows on the working surface of the module.

Moreover, the majority of ideas for improvement to the system were suggestions for specific medical procedures or games that the surgeons would like to have for use in training. In particular, the surgical residents liked the idea of using games to improve their skills. They especially liked playing with the miniature blocks, as a Nanoblocks® module, as it challenged their ability to move and manipulate small objects with the surgical tools in order to construct items. Thus, Nanoblocks® modules and modules containing miniature building materials are contemplated for use in combination with using surgical tools in order to challenge the ability of medical practitioners' ability to move and manipulate small objects with specific surgical tools.

Several surgeons suggested adding retractor bars to the system in order to simulate pulling back layers of tissue during an operation. Thus, in one contemplated embodiment, retractor bars will be added to the system in order to simulate pulling back layers of tissue during an operation. In one embodiment, a holder for a retractor bar is added to a lid.

The surgeons would like to have more modules that realistically replicate complex medical tasks, for example, modules could incorporate a pump system to simulate blood flow, which would increase complexity and provide more realistic aneurysm or anastomosis practice scenarios. Thus, in another contemplated embodiment, modules will incorporate a pump system to simulate blood flow, for increasing complexity of the training and to provide more realistic practice scenarios, including but not limited to aneurysm and anastomosis surgical training. In one embodiment, fluid for simulating blood flow may be dyed, i.e. colored red, green, orange, etc. In one embodiment, use of a colored fluid may increase a stress factor, i.e. degree of difficulty, as part of the simulation.

Modules could be also be used to compare and benchmark surgical instruments. Moreover, modules could be developed to serve as a reference for particular scenarios as observed in the operating room.

Further, modules may be used to compare effectiveness of different types of surgical instruments. Moreover, training modules may be developed to serve as a reference for particular surgical scenarios as encountered in the operating room.

### Example III

This example describes exemplary methods for evaluating the effectiveness of the training modules and cartridges.

Exemplary Performance Test: Timing and Accuracy.

In order to evaluate the user's performance when using a training module or cartridge, the following criteria may be used.

Time: how long did it take the user to perform the task from beginning to end. For example, the time it takes for the user to complete a task may be recorded, such as the time it took for suturing blood vessels together. In other embodiments, timing may be controlled by a timer. For example, a user may be required to repair a microvessel within a specific time, otherwise the micro-vessel may begin to leak fluid or may be timed to rupture releasing fluid if not repaired within a specific time frame. In some embodiments, the time may be changed, i.e. shortened for increasing the degree of difficulty.

Accuracy: A task, such as a suturing task, can be evaluated for accuracy by injecting water into the sutured blood vessels to check for a tight seal, i.e. no water leakage, to determine whether the suturing task was accurately completed. If the suturing does not hold water, then the user failed the exercise. In anther example, the completed task is evaluated for whether the springs are still holding the blood vessels after suturing is completed. As another example, a task whereby the user is placing rings or beads on rod magnets, accuracy is determined by counting how many rings or beads were placed on the rods without knocking them off the magnets. When the rods are made of glass, counting how many rings or beads are placed on the rod before knocking the glass magnetic rods off of the magnets or by breaking the glass rods. In some embodiments, accuracy determinations has instant feedback, such as when a LED light or other light emitting device or a buzzer, or similar device, turns on when a user does not conform to a particular movement or task, such as when using surgical instruments to pick up a recessed item. When a user touches the surgical instrument to the outside edge of the recess instead of onto the item, a light or buzzer is immediately activated.

Exemplary Performance Test: Qualitative Performance.

A performance evaluation is contemplated for style of completion and style of movements. Using for example a blood vessel suturing task, the completed task can be qualitatively evaluated by determining the number of sutures and/or whether the sutures are evenly spaced.

In another embodiment of a performance evaluation, a side-by-side observation of movements while working on the task is evaluated. For this example, a stereomicroscope has the capability for two users to view the same image, i.e. module/cartridge. This duel viewing may be accomplished by an auxiliary extension tube whereby a secondary user is able to watch the movements of the primary user who is actually performing a module or cassette task. This allows the secondary user to evaluate the performance of the primary user. An example of such an evaluation is where the secondary user observes whether the primary user drops the needle during suturing for the blood vessel suturing task.

One example of an auxiliary extension tube for side by side observation is an Olympus Side by side discussion tube, part no. SZX-SDO2.

Another example of evaluating performance is by evaluating a videotape of a user performing a task. For this example, a stereomicroscope has a beam splitter attachment or attachment capable of allowing simultaneously viewing of an image by a user while a camera records the user's movements. As one example of such an attachment, an Olympus Light Beam Splitter, part no. SZX2-LBS or a part providing a similar capability might be used. This type of bean splitter allows a light path that can be changed between 100% observation, 100% digital camera, and 50% observation and 50% to both left and right cameras, as an example.

Changing the Task and Increasing the Difficulty of a Performance Test.

In some embodiments, after the initial task is successfully performed, as determined by exemplary criteria described above, the task is changed and/or degree of difficulty is increased. For example using the blood vessel suturing task, the springs holding the blood vessels may be changed, such that the blood vessels are held by different springs, the blood vessels are pointing in different directions, etc.

### Example IV

This example describes exemplary methods for using training modules and cartridges as teaching tools.

Conversely, the use of side-by-side observations described in the previous example may be for education. As one example, where the primary user (educator) is teaching the proper means of completing a task, such as suturing together blood vessels, to a secondary user (student).

In another embodiment, a primary user may teach the proper means for completing a task or type of microsurgery to a group of students. For this embodiment, the image of the user's movements while performing a task in a module or cartridge are shown in real time or recorded for later use. This type of teaching may be accomplished using exemplary beam splitting parts as described in the previous example.

All publications and patents mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in medicine, surgery, neurosurgery, microsurgery, vascular surgery, cardiovascular surgery, plastic surgery, ophthalmology, microscopy, or related fields are intended to be within the scope of the following claims.

1. A rotational docking station gimbal comprising, a full gimbal ring capable of providing a roll rotation, wherein said full gimbal ring is a module docking station, a half gimbal ring capable of providing a pitch rotation, and a quarter gimbal ring capable of providing a yaw rotation.

2. The gimbal of claim 1, wherein said docking station contains a module.

3. The gimbal of claim 1, wherein said quarter ring gimbal has a component for attaching to a base.

4. A cylindrical module cassette having two ends, wherein one end is open, wherein said open end is attached to a lid comprising an opening and a plurality of light-emitting diodes.

5. The cassette of claim 4, wherein said lid further comprises a light switch and an attachment for a retractor bar.

6. The cassette of claim 4, further comprising a module, wherein said module comprises springs for holding imitation blood vessels.

7. A cylindrical module cartridge having two ends, wherein one end is open end and a side connecting each end, wherein a plurality of magnets are embedded into said side.

8. The cylindrical module cartridge of claim 7, further comprising materials selected from the group consisting of, a plurality of hoop magnets capable of magnetically attaching to said embedded magnets, a replica of a blood vessel, wherein said blood vessel has magnets on each end capable of magnetically attaching to said embedded magnets and a bleb simulating an aneurysm, and at least one magnetic rod with a plurality of beads which are capable of being slid onto said magnetic rod.

9. The cylindrical module cartridge of claim 7, further comprising a lid, wherein said lid has a plurality of light emitting diodes.

10. The cylindrical module cartridge of claim 7, wherein said cartridge is located inside of a docking station of a rotational docking station gimbal, wherein said gimbal comprises, a full gimbal ring capable of providing a roll rotation, wherein said full gimbal ring is said cartridge docking station, a half gimbal ring capable of providing a pitch rotation, and a quarter gimbal ring capable of providing a yaw rotation.

11. The gimbal of claim 1, further comprising a base.

12. The gimbal of claim 11, wherein said base is a spring base for providing planar movement to an attached rotational docking station gimbal.

13. A system, comprising:
a) a module, and
b) a rotational docking station gimbal comprising, a full gimbal ring capable of providing a roll rotation, wherein said full gimbal ring provides a module docking station, a half gimbal ring capable of providing a pitch rotation, and a quarter gimbal ring capable of providing a yaw rotation.

14. The system of claim 13, wherein said module is located within the docking station of said gimbal.

15. The system of claim 13, wherein said module further comprises a cylindrical module cassette.

16. The system of claim 13, wherein said module comprises at least one synthetic blood vessel and a plurality of springs for holding said blood vessel.

17. The system of claim 13, wherein said module is a cylindrical module cartridge.

18. The system of claim 13, further comprises a base selected from the group consisting of a stationary base and a spring base.

19. The system of claim 13, wherein said spring base provides a capability of planar movement to said gimbal.

20. The system of claim 13, further comprising an optical system.
